(19) United States
(12) Patent Application Publication
(10) Pub. No.: US 2023/0130812 A1
(43) Pub. Date: Apr. 27, 2023

(54) SECONDARY BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Yuji IWAKI, Isehara, Kanagawa (JP)

(21) Appl. No.: 17/905,582

(22) PCT Filed: Mar. 9, 2021
(86) PCT No.: PCT/IB2021/051924

§ 371 Date: Sep. 2, 2022

(30) Foreign Application Priority Data
Mar. 18, 2020 (JP) 2020-047990

(51) Int. Cl. H01M 4/62; H01M 4/525; H01M 4/36; H01M 4/505

(52) U.S. Cl. CPC H01M 4/628; H01M 4/525; H01M 4/366; H01M 4/505

(57) ABSTRACT

A positive electrode active material with high charge and discharge capacity is provided. Alternatively, a positive electrode active material with high charge and discharge voltages is provided. Alternatively, a power storage device that hardly deteriorates is provided. Alternatively, a highly safe power storage device is provided. Alternatively, a novel power storage device is provided. Provided is a positive electrode active material containing lithium, a plurality of transition metals, oxygen, and an impurity element. The positive electrode active material has a first region including a surface portion and a second region provided in an inner portion; the first region and the second region differ in the concentration of a transition metal. An impurity layer is included between the first region and the second region.

### TECHNICAL FIELD

Embodiments of the present invention relate to a secondary battery including a positive electrode active material and a fabrication method thereof. Other embodiments of the present invention relate to a portable information terminal, a vehicle, and the like each including the secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Thus, improvement of a positive electrode active material has been studied to increase the cycle performance and the capacity of the lithium-ion secondary battery (e.g., Patent Document 1).

The performances required for power storage devices are safe operation and longer-term reliability under various environments, for example.

### REFERENCE

### Patent Document

[Patent Document 1]
Japanese Published Patent Application No. 2019-21456

### SUMMARY OF THE INVENTION

### Problems to be Solved by the Invention

An object of one embodiment of the present invention is to provide a positive electrode active material with high charge and discharge capacity. Another object is to provide a positive electrode active material with high charge and discharge voltage. Another object is to provide a positive electrode active material that hardly deteriorates. Another object is to provide a novel positive electrode active material. Another object is to provide a secondary battery with high charge and discharge capacity. Another object is to provide a secondary battery with high charge and discharge voltage. Another object is to provide a highly safe or reliable secondary battery. Another object is to provide a secondary battery that hardly deteriorates. Another object is to provide a secondary battery with a long lifetime. Another object is to provide a novel secondary battery.

Another object of one embodiment of the present invention is to provide a novel substance, a novel active material, a novel power storage device, or a fabrication method thereof.

Note that the description of these objects does not preclude the existence of other objects. One embodiment of the present invention does not have to achieve all these objects. Other objects can be derived from the description of the specification, the drawings, and the claims.

Another object is to provide a vehicle that includes a secondary battery of one embodiment of the present invention and has a long cruising range; specifically, whose one charge mileage (charge mileage) is greater than or equal to 300 km, preferably greater than or equal to 500 km. Note that one charge mileage refers to mileage that a vehicle actually runs after charge of an in-vehicle secondary battery with an external power source such as a charge station until the next charge with the use of an external power source. That is, one charge mileage corresponds to the longest distance that a vehicle can run with a fully charged state after one charge of a secondary battery with the use of an external power source, and can be referred to as mileage per charge.

### Means for Solving the Problems

One embodiment of the present invention is a secondary battery containing a positive electrode active material. In the secondary battery, the positive electrode active material includes a first region and a second region provided inward from the first region; each of the first region and the second region contains lithium, oxygen, and one or more selected from a first transition metal, a second transition metal, and a third transition metal; and the first region and the second region differ in a concentration of at least one of the first transition metal, the second transition metal, and the third transition metal.

In the above, it is preferable that the positive electrode active material include an impurity layer containing an impurity element, and the impurity layer be provided between the first region and the second region.

In the above, the impurity layer preferably has a function of inhibiting interdiffusion of elements contained in the first region and the second region.

In the above, the impurity element is preferably at least one of titanium, fluorine, magnesium, aluminum, zirconium, calcium, gallium, niobium, phosphorus, boron, and silicon.

Another embodiment of the present invention is a secondary battery containing a positive electrode active material. In the secondary battery, the positive electrode active material includes a first region, a second region provided inward from the first region, a first impurity layer provided on an outer side than the first region, and a second impurity layer provided between the first region and the second region; each of the first region and the second region contains lithium, oxygen, and one or more selected from a first transition metal, a second transition metal, and a third transition metal; the first region and the second region differ in a concentration of at least one of the first transition metal, the second transition metal, and the third transition metal; and impurity elements contained in the first impurity layer and the second impurity layer are at least one of titanium, fluorine, magnesium, aluminum, zirconium, calcium, gallium, niobium, phosphorus, boron, and silicon.

In the above, the impurity layer preferably has a function of inhibiting interdiffusion of elements contained in the first region and the second region.

In the above, it is preferable that the first transition metal be nickel, the second transition metal be cobalt, the third transition metal be manganese, a concentration of cobalt be higher in the first region than in the second region, and concentrations of nickel and manganese be lower in the first region than in the second region. Resources of cobalt are limited, and thus the material cost of the positive electrode active material can be reduced when the usage of cobalt is reduced. Nickel has more resources than cobalt and it can be said that nickel is an eco-friendly transition metal; thus, in the case where a low-cost secondary battery is fabricated, it is preferable to use more nickel than cobalt.

In the above, the first region preferably promotes diffusion of lithium due to charge and discharge to contribute to stabilization of the positive electrode active material.

In the above, it is preferable that the secondary battery contain a carbon material and the carbon material be at least one of fibrous carbon, graphene, and particulate carbon. These carbon materials are used as conductive materials (also referred to as conductivity-imparting agents or conductive additives). A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other. Note that fibrous carbon means a carbon nanotube (also referred to as a CNT) or the like. Since graphene has a thin surface-like shape, an efficient conduction path can be formed with a smaller amount than another carbon material and the active material proportion can be high; thus, the capacity per volume of an electrode is increased. Accordingly, the secondary battery can have a small size and high capacity. Furthermore, the use of graphene can inhibit a decrease in capacity due to fast charge and discharge. Graphene in this specification and the like includes not only single-layer graphene but also multi graphene and multilayer graphene. The multilayer graphene includes two or more and a hundred or less layers of carbon sheets, for example. In addition, particulate carbon means carbon black (e.g., furnace black, acetylene black (also referred to as AB), or graphite). Note that the conductive material preferably includes graphene. The use of graphene as the conductive material might inhibit deterioration of the positive electrode active material due to charge and discharge. For example, the positive electrode active material deteriorates from its surface portion by the influence of cation mixing during charge and discharge, in some cases. In this case, the deterioration can be inhibited by employing a structure including graphene as a conductive material.

Another embodiment of the present invention is an electronic device including the secondary battery described above.

Another embodiment of the present invention is a vehicle including the secondary battery described above. A highly safe or reliable secondary battery with high energy density can be achieved with the use of the above positive electrode active material; thus, the secondary battery is preferable for a next-generation clean energy vehicle in which a large battery including a plurality of secondary batteries is incorporated, such as a hybrid vehicle, an electric vehicle, or a plug-in hybrid vehicle, for example.

### Effect of the Invention

According to one embodiment of the present invention, a positive electrode active material with high energy density and high charge and discharge capacity can be provided. Alternatively, a positive electrode active material with high energy density and high charge and discharge voltage can be provided. Alternatively, a positive electrode active material that hardly deteriorates can be provided. Alternatively, a novel positive electrode active material can be provided. Alternatively, a secondary battery with high charge and discharge capacity can be provided. Alternatively, a secondary battery with high charge and discharge voltage can be provided. Alternatively, a highly safe or reliable secondary battery can be provided. Alternatively, a secondary battery that hardly deteriorates can be provided. Alternatively, a secondary battery with a long lifetime can be provided. Alternatively, a novel secondary battery can be provided.

When an attempt is made to increase capacity by increasing the number of secondary batteries to increase one charge mileage, the total weight of the vehicle might be increased and energy to move the vehicle might be increased, leading to short one charge mileage. The use of the secondary battery with high energy density disclosed in one embodiment of the present invention can make one charge mileage longer with only a little change in the total weight of the vehicle including secondary batteries with the same weight.

Thus, according to one embodiment of the present invention, a vehicle including a novel power storage device can be provided.

According to one embodiment of the present invention, a novel substance, a novel active material, a novel power storage device, or a fabrication method thereof can be provided.

Note that the description of these effects does not preclude the existence of other effects. One embodiment of the present invention does not have to have all these effects. Other effects will be apparent from and can be derived from the description of the specification, the drawings, the claims, and the like.

### BRIEF DESCRIPTION OF THE DRAWINGS

FIG. 1A to FIG. 1C are examples of cross-sectional views of a positive electrode active material.

FIG. 2A to FIG. 2C are examples of cross-sectional views of a positive electrode active material.

FIG. 3A and FIG. 3B are examples of cross-sectional views of a positive electrode active material.

FIG. 4A1, FIG. 4B1, FIG. 4C1, FIG. 4D1, and FIG. 4E1 are examples of perspective views of a positive electrode active material. FIG. 4A2, FIG. 4B2, FIG. 4C2, FIG. 4D2, and FIG. 4E2 are examples of cross-sectional views of a positive electrode active material.

FIG. 5A and FIG. 5B are diagrams for illustrating examples of a method for forming a positive electrode active material.

FIG. 6 is a diagram illustrating the charge depth and crystal structures of a positive electrode active material.

FIG. 7 is a diagram illustrating the charge depth and crystal structures of a positive electrode active material.

FIG. 8A to FIG. 8D are cross-sectional views illustrating examples of a positive electrode of a secondary battery.

FIG. 9A and FIG. 9B are diagrams illustrating examples of a secondary battery.

FIG. 10A to FIG. 10C are diagrams illustrating an example of a secondary battery.

FIG. 11A and FIG. 11B are diagrams illustrating an example of a secondary battery.

FIG. 12A to FIG. 12C are diagrams illustrating a coin-type secondary battery.

FIG. 13A is a top view illustrating a secondary battery, and FIG. 13B is a cross-sectional view illustrating the secondary battery.

FIG. 14A to FIG. 14C are diagrams illustrating an example of a secondary battery.

FIG. 15A to FIG. 15C are diagrams illustrating a secondary battery.

FIG. 16A is a perspective view of a battery pack of one embodiment of the present invention, FIG. 16B is a block diagram of a battery pack, and FIG. 16C is a block diagram of a vehicle including a motor.

FIG. 17A and FIG. 17B are diagrams illustrating power storage devices of one embodiment of the present invention.

FIG. 18A and FIG. 18B are diagrams illustrating examples of electronic devices, and FIG. 18C to FIG. 18F are diagrams illustrating examples of transport vehicles.

FIG. 19A is a diagram illustrating an electric bicycle, FIG. 19B is a diagram illustrating a secondary battery of the electric bicycle, and FIG. 19C is a diagram illustrating an electric motorcycle.

FIG. 20A illustrates examples of wearable devices, FIG. 20B illustrates a perspective view of a watch-type device, FIG. 20C is a diagram illustrating a side surface of the watch-type device, and FIG. 20D is a perspective view illustrating a head-mounted display.

FIG. 21 is a graph showing the proportion of the radius of a region 191 when the radius of a particle 190 is set to 1 and the volume proportions of the region 191 and a region 193.

FIG. 22A is a graph showing the radius and discharge capacity per weight of the region 191 when NCM811 is used for the region 191 and LiCoO₂ is used for the region 193, and FIG. 22B is a graph showing the radius of the region 191 and discharge capacity per weight when LiCoO₂ is used for the region 191 and NCM811 is used for the region 193.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

In this specification and the like, crystal planes and orientations are indicated by the Miller index. In the crystallography, a bar is placed over a number in the expression of crystal planes and crystal orientations; in this specification and the like, because of application format limitations, crystal planes, crystal orientations, and space groups are sometimes expressed by placing a minus sign (−) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like is a region that is less than or equal to 50 nm, preferably less than or equal to 35 nm, further preferably less than or equal to 20 nm, most preferably less than or equal to 10 nm from the surface, for example. A plane generated by cracking or a crack may also be referred to as a surface. In addition, a region in a deeper position than a surface portion is referred to as an inner portion. In this specification and the like, particles are not limited to be spherical (with a circular cross section). Other examples of the cross-sectional shapes of particles include an ellipse, a rectangle, a trapezoid, a cone, a quadrilateral with rounded corners, and an asymmetrical shape, and a particle may have an indefinite shape.

In this specification and the like, a layered rock-salt crystal structure of a composite oxide including lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, an O3′ type crystal structure that a composite oxide containing lithium and a transition metal has belongs to the space group R-3m, and an ion of cobalt, magnesium, or the like occupies a site coordinated to six oxygen atoms. Furthermore, the symmetry of CoO₂ layers of this structure is the same as that in the O3 type structure. This structure is thus referred to as an O3′ type crystal structure in this specification and the like. Note that in the O3′ type crystal structure, a light element such as lithium sometimes occupies a site coordinated to four oxygen atoms.

The O3′ type crystal structure can be regarded as a crystal structure that contains lithium between layers randomly and is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, simple and pure lithium cobalt oxide or a layered rock-salt positive electrode active material containing a large amount of cobalt is known not to have this crystal structure in general.

Anions of a layered rock-salt crystal and anions of a rock-salt crystal form a cubic close-packed structure (face-centered cubic lattice structure). Anions of an O3′ crystal are presumed to form a cubic close-packed structure. Note that in this specification and the like, a structure is referred to as cubic close-packed when three layers of anions are shifted and stacked like “ABCABC” in the structure. Accordingly, anions do not necessarily form a cubic lattice. At the same time, actual crystals always have a defect and thus, analysis results are not necessarily consistent with the theory. For example, in electron diffraction or FFT (fast Fourier transform) of a TEM image or the like, a spot may appear in a position slightly different from a theoretical position. For example, anions may be regarded as forming a cubic close-packed structure when a difference in orientation from a theoretical position is less than or equal to 5° or less than or equal to 2.5°.

When a layered rock-salt crystal and a rock-salt crystal are in contact with each other, there is a crystal plane at which orientations of cubic close-packed structures composed of anions are aligned. The above phenomenon can also be described as follows. Anions on the (111) plane of a cubic crystal structure are arranged triangularly. A layered rock-salt structure, which belongs to a space group R-3m and is a rhombohedral structure, is generally represented by a composite hexagonal lattice for easy understanding of the structure, and the (0001) plane of the layered rock-salt structure has a hexagonal lattice. The triangle lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned”. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal; thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned is referred to as a state where crystal orientations are substantially aligned in some cases.

The orientations of crystals in two regions being substantially aligned with each other can be judged, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscopy) image, or the like. For judging, XRD (X-ray Diffraction), electron diffraction, neutron diffraction, and the like can also be used. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all the lithium that can be inserted and extracted is inserted is 0, and the charge depth obtained when all the lithium that can be inserted and extracted in a positive electrode active material is extracted is 1.

In addition, in this specification and the like, charge refers to transfer of lithium ions from a positive electrode to a negative electrode in a battery and transfer of electrons from a positive electrode to a negative electrode in an external circuit. For a positive electrode active material, extraction of lithium ions is called charge. A positive electrode active material with a charge depth of greater than or equal to 0.7 and less than or equal to 0.9 may be referred to as a positive electrode active material charged with a high voltage.

Similarly, discharge refers to transfer of lithium ions from a negative electrode to a positive electrode in a battery and transfer of electrons from a negative electrode to a positive electrode in an external circuit. Discharge of a positive electrode active material refers to insertion of lithium ions. Furthermore, a positive electrode active material with a charge depth of less than or equal to 0.06 or a positive electrode active material from which more than or equal to 90% of the charge capacity is discharged from a state where the positive electrode active material is charged with a high voltage is referred to as a sufficiently discharged positive electrode active material.

In this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

The discharge rate refers to the relative ratio of a current at the time of discharge to battery capacity and is expressed in a unit C. A current corresponding to 1 C in a battery with a rated capacity X (Ah) is X (A). The case where discharge is performed with a current of 2X (A) is rephrased as to perform discharge at 2 C, and the case where discharge is performed with a current of X/5 (A) is rephrased as to perform discharge at 0.2 C. The same applies to the charge rate; the case where charge is performed with a current of 2X (A) is rephrased as to perform charge at 2 C, and the case where charge is performed with a current of X/5 (A) is rephrased as to perform charge at 0.2 C.

Constant current charge refers to a charge method with a fixed charge rate, for example. Constant voltage charge refers to a charge method in which voltage is fixed when reaching the upper voltage limit, for example. Constant current discharge refers to a discharge method with a fixed discharge rate, for example.

In this specification and the like, an approximate value of a given value A refers to a value greater than or equal to 0.9A and less than or equal to 1.1A.

### Embodiment 1

A particle of one embodiment of the present invention can be used as a material of an electrode in a secondary battery. The particle of one embodiment of the present invention functions as an active material. The active material is, for example, a substance that performs a reaction contributing to charge and discharge capacity. Note that the active material may partly contain a substance that does not contribute to the charge and discharge capacity.

The particle of one embodiment of the present invention can be used particularly as a positive electrode material of a secondary battery. The particle of one embodiment of the present invention functions particularly as a positive electrode active material. The positive electrode active material is a substance that performs a reaction contributing to charge and discharge capacity and is a substance used as a material of a positive electrode, for example. Note that the positive electrode active material may partly contain a substance that does not contribute to the charge and discharge capacity. A particle, an active material, a positive electrode material, or a positive electrode active material containing at least lithium, a transition metal, and oxygen may be referred to as a composite oxide.

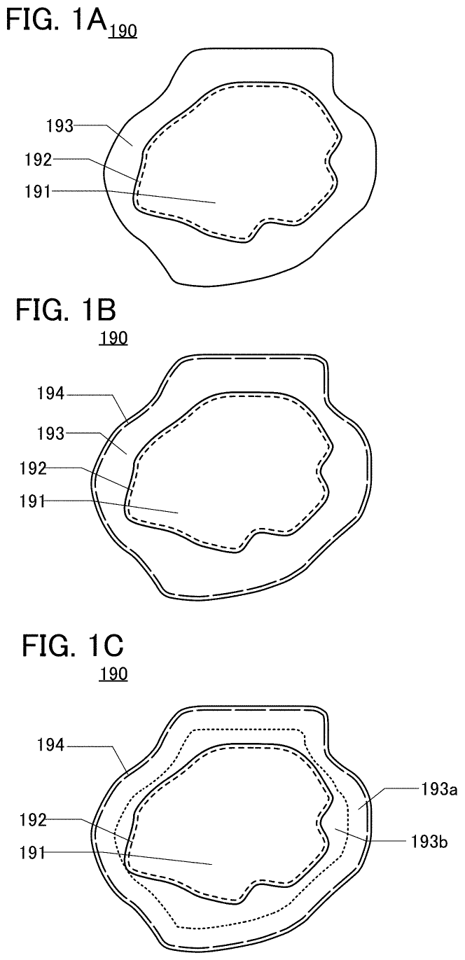

FIG. 1A is an example of a cross section of a particle 190 of one embodiment of the present invention. The particle 190 illustrated in FIG. 1A has a region 191, a region 192, and a region 193.

The region 191 is provided inward from the region 193. The region 192 is provided between the region 191 and the region 193.

The region 193 is a region including a surface portion of the particle 190. The region 192 is a region positioned inward from the region 193. The region 191 is a region positioned inward from the region 192. The region 191 is an inner portion of the particle 190 and is a region including the center of the particle, for example. The center of the particle means the center of gravity of the particle, and the position thereof can be determined by using an electron microscope or the like. The center of the particle is, for example, when the particle is cut and its cross section is observed, the center of the minimum circumcircle of a cross section having a maximum cross-sectional area or a cross section whose cross-sectional area is 90% or more of the maximum cross-sectional area.

The region 192 is, for example, a region positioned between the region 191 and the region 193.

The region 191 is referred to as a “core” and the region 193 is referred to as a “shell” in some cases.

The region 191 and the region 192 are collectively referred to as a “core” and the region 193 is referred to as a “shell” in other cases. In such a case, the region 192 may be expressed as a surface portion of the “core”. Alternatively, the region 192 may be expressed as an impurity layer.

The expression “the particle 190 has a core-shell structure (also referred to as a core-shell type structure)” is used in some cases.

The average particle diameter (also referred to as a median diameter or D50) of the particle 190 is preferably greater than or equal to 0.1 μm and less than or equal to 50 μm, further preferably greater than or equal to 1 μm and less than or equal to 30 μm.

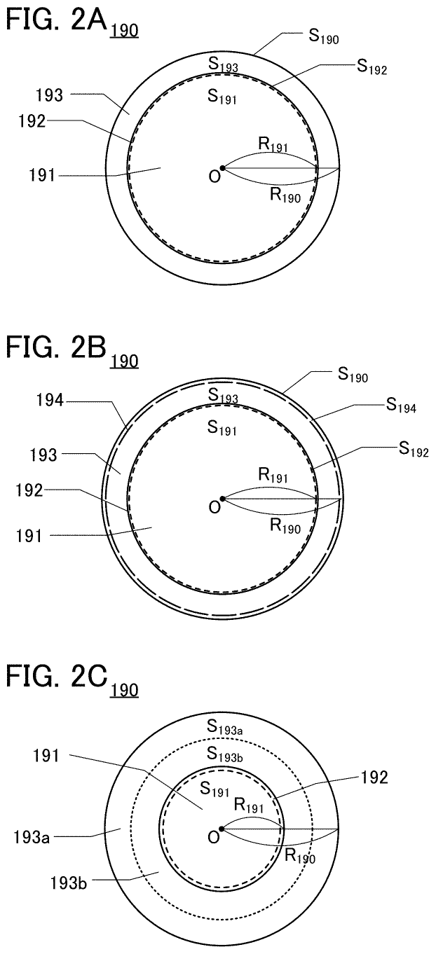

The region 191 has a particulate shape. The proportion of the area of the region 191 in the cross section of the particle 190, i.e., S₁₉₁/S₁₉₀, is preferably greater than or equal to 0.04% and less than or equal to 96.0%, further preferably greater than or equal to 30% and less than or equal to 90%, still further preferably greater than or equal to 64% and less than or equal to 90%. As illustrated in FIG. 2A, the area of the region 191 is referred to as S₁₉₁, the area of the region 192 is referred to as S₁₉₂, the area of the region 193 is referred to as S₁₉₃, and the cross-sectional area of the particle 190 is referred to as S₁₉₀ (S₁₉₀=S₁₉₁+S₁₉₂+S₁₉₃). Note that the distance from a center O to a surface of the particle 190 is referred to as R₁₉₀. The distance from the center O of the particle 190 to a surface of the particulate shape of the region 191 is referred to as R₁₉₁.

It is preferable that at least part of the region 192 be in contact with the surface of the particulate shape of the region 191. Alternatively, it is preferable that the region 192 be provided to cover at least part of the surface of the particulate shape of the region 191. It is preferable that at least part of the region 192 be placed at a position farther from the center O of the particle 190 than the region 191.

The region 192 is preferably provided between the region 191 and the region 193. The region 192 is preferably a layer that covers at least part of the surface of the particulate shape of the region 191. The region 192 is preferably a layer with a thickness greater than or equal to 0.5 nm and less than or equal to 100 nm, further preferably a layer with a thickness greater than or equal to 1 nm and less than or equal to 30 nm, for example. Note that the thickness of the region 192 is not necessarily uniform.

The region 192 preferably has a function of inhibiting interdiffusion of elements contained in the region 191 and the region 193 at the time of synthesis. The region 192 preferably has a function of not preventing interdiffusion of lithium during charge and discharge or a function of promoting interdiffusion of lithium.

It is preferable that at least part of the region 193 be placed at a position farther from the center O of the particle 190 than the region 191 and the region 192. The region 193 preferably overlaps with at least one of the region 191 and the region 192. The region 193 preferably has a layered form. Alternatively, the proportion of the area of the region 193 in the cross section of the particle 190 is preferably greater than or equal to 4% and less than or equal to 99.96%, further preferably greater than or equal to 10% and less than or equal to 70%, still further preferably greater than or equal to 10% and less than or equal to 36%. Note that the thickness of the region 193 is not necessarily uniform.

The region 193 preferably has a function of promoting diffusion of lithium due to charge and discharge to contribute to stabilization of a positive electrode active material. The region 193 preferably has a function of inhibiting deterioration of a positive electrode active material due to charge and discharge. For example, the positive electrode active material deteriorates from its surface portion by the influence of cation mixing during charge and discharge, in some cases. In that case, the region 193 preferably has a structure that is less influenced by the cation mixing. The region 193 is not necessarily one region and may be two or more regions. For example, the region 193 can have two regions: a region 193b provided on an inner side and a region 193a provided outside the region 193b.

As illustrated in FIG. 1B, the particle 190 may have a region 194. The region 194 is provided outside the region 193. In that case, the region 193 and the region 194 are collectively referred to as a “shell” in some cases. The region 194 may be expressed as a surface portion of the “shell”, the surface portion of the particle 190, or including the surface of the particle 190, in some cases. The region 194 is expressed as an impurity layer or an impurity region in some cases. As illustrated in FIG. 2B, the area of the region 194 is referred to as S₁₉₄, and the area of the particle 190 having the region 194 is referred to as S₁₉₀ (S₁₉₀=S₁₉₁+S₁₉₂+S₁₉₃+S₁₉₄).

It is preferable that at least part of the region 194 be placed at a position farther from the center O of the particle 190 than the region 193. The region 194 preferably overlaps with at least one of the region 191, the region 192, and the region 193. At least part of the region 194 overlaps with the region 193. The region 194 is preferably a layer with a thickness greater than or equal to 0.5 nm and less than or equal to 100 nm, further preferably a layer with a thickness greater than or equal to 1 nm and less than or equal to 30 nm, for example. Note that the thickness of the region 194 is not necessarily uniform.

It is preferable that the region 194 also have a structure that is less influenced by cation mixing. In the case where the region 194 is included, the region 194 is the outermost region of the particle 190; thus, when cation mixing in the region 194 is inhibited and collapse of the crystal structure is inhibited, an effect of inhibiting deterioration of charge and discharge characteristics or the like might be particularly high.

The diameter of the particle can be measured with a particle size distribution analyzer, for example. The proportion of the area of the region 191, the region 193, or the like in the cross section can be estimated by cross-sectional observation and various kinds of line analyses, surface analyses, or the like after the cross section is exposed by processing the particle 190. It is preferable that a cross section sufficiently reflecting the internal structure of the particle 190 be used to estimate the proportion of the area. For example, a cross section whose maximum width is 80% or more of the average particle diameter (D50) is preferably used.

The thickness or the like of each region can be similarly estimated by cross-sectional observation and various kinds of line analyses, surface analyses, or the like after the cross section is exposed by processing.

### <Composite Oxide>

A material into and from which lithium ions can be inserted and extracted can be used for the region 191 and the region 193. Note that in the case where carrier ions are alkali metal ions other than lithium ions, or alkaline earth metal ions, an alkali metal (e.g., sodium or potassium) or an alkaline earth metal (e.g., calcium, strontium, barium, beryllium, or magnesium) may be used instead of lithium. In the case where the region 191 and the region 193 serve as a positive electrode active material, a compound having an olivine crystal structure, a layered rock-salt crystal structure, a spinel crystal structure, or the like is preferably used, for example. The compound having a layered rock-salt crystal structure includes what is called a lithium-excess compound whose atomic ratio of lithium to a transition metal is greater than 1. It is particularly preferable to use a composite oxide that has a layered rock-salt crystal structure and belongs to the space group R-3m. Note that the material is not limited thereto depending on functions of the region 191 and the region 193.

Each of the region 191 and the region 193 preferably contains a transition metal. Specifically, one or more of cobalt, nickel, and manganese are preferably contained.

The concentration of at least one of transition metals contained in the region 191 and the region 193 preferably differs between the region 191 and the region 193.

Note that in the case where two or more kinds of transition metals are used, two kinds of transition metals of cobalt and manganese, two kinds of transition metals of cobalt and nickel, or two kinds of transition metals of nickel and manganese may be used. Alternatively, three kinds of transition metals, cobalt, manganese, and nickel, may be used. In other words, each of the region 191 and the region 193 can contain a composite oxide containing lithium and a transition metal, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

### Example 1 of Particle

Described as a specific example of the particle 190 is an example in which LCNO (lithium cobalt oxide in which nickel is substituted for part of cobalt) is used for the core and LCO (lithium cobalt oxide) is used for the shell, i.e., an example in which a Li—Co—Ni oxide containing two kinds of transition metals, cobalt as the first transition metal and nickel as the second transition metal, is used for the region 191 and a Li—Co oxide is used for the region 193.

In the case where the molar ratio of the metal elements in the Li—Co—Ni oxide (LCNO) used for the region 191 is Li:Co:Ni=1:1−x:x, x preferably satisfies 0<x<1, further preferably 0.3<x<0.75, still further preferably 0.4×0.6.

As the Li—Co oxide (LCO) used for the region 193, a composite oxide represented by LiCo_{y}O_{z} (z=2 or the neighborhood thereof, and 0.8<y<1.2) is preferably used, for example.

For examples of a composite oxide that can be used for the region 192, the descriptions of the region 191 and the region 193 can be referred to. For examples of a composite oxide that can be used for the region 194, the description of the region 193 can be referred to.

### Example 2 of Particle

Described as a specific example of the particle 190 is an example in which the first LCNO is used for the core and the second LCNO is used for the shell, i.e., an example in which a Li—Co—Ni oxide containing two kinds of transition metals, cobalt as the first transition metal and nickel as the second transition metal, is used for the region 191 and a Li—Co—Ni oxide containing two kinds of transition metals, cobalt as the first transition metal and nickel as the second transition metal, is used for the region 193.

In the case where the molar ratio of the metal elements in the first Li—Co—Ni oxide used for the region 191 is Li:Co:Ni=1:1−x:x and the molar ratio of the metal elements in the second Li—Co oxide used for the region 193 is Li:Co:Ni=1:1−w:w, it is preferable that x and w satisfy 0<x<1, 0<w<1, and w<x, it is further preferable that x and w satisfy 0.3<x<0.75 and w<x, it is still further preferable that x and w satisfy 0.3<x<0.75 and w≤0.3, it is still further preferable that x and w satisfy 0.4≤x≤0.6 and w<x, and it is still further preferable that x and w satisfy 0.4≤x≤0.6 and w<0.4. The above ranges are preferable because a secondary battery exhibiting excellent cycle performance at high temperatures (e.g., 45° C. or higher) can be obtained.

In a composite oxide having a layered rock-salt crystal structure, a large amount of lithium extracted during charge easily causes release of oxygen and cation mixing, in which case the crystal structure tends to be collapsed easily. In the particle 190 having such a structure, however, a large amount of cobalt is contained in the region 193 serving as the shell and the average discharge voltage is high; thus, lithium is likely to remain at the region 193. Accordingly, collapse of the crystal structure in the region 193 and the entire particle 190 can be inhibited. Thus, a phase (e.g., a NiO domain having a rock-salt crystal structure generated by cation mixing) where lithium is less likely to be inserted into the surface portion is less likely to be caused even when charge and discharge are repeated. As a result, decreases in discharge capacity and discharge voltage can be inhibited.

For a composite oxide used for the region 192, the descriptions of the region 191 and the region 193 can be referred to. For a composite oxide used for the region 194, the description of the region 193 can be referred to.

### Example 3 of Particle

Described as a specific example of the particle 190 is an example in which NCM (lithium nickel-manganese-cobalt oxide) is used for the core and LCO is used for the shell, i.e., an example in which a lithium composite oxide containing three kinds of transition metals, cobalt as the first transition metal, nickel as the second transition metal, and manganese as the third transition metal, is used for the region 191 and a Li—Co oxide is used for the region 193. In the case of the structure in which NCM is used for the core and LCO is used for the shell, the content of cobalt, which is expensive, in the entire positive electrode active material can be low; thus, the overall price of the positive electrode active material can be lower than that of a positive electrode active material containing only LCO. Furthermore, in the case of the structure in which NCM is used for the core and LCO is used for the shell, sufficient discharge capacity can be ensured at a charge voltage within a range of higher than or equal to 4.2 V and lower than 4.6 V (vs. Li/Li⁺). When NCM is used for the core, the stability in repeated charge and discharge or in long-term uses can be higher than that of the positive electrode active material containing only LCO.

As the lithium composite oxide containing cobalt, nickel, and manganese, a NiCoMn-based material represented by LiNiₓCo_{y}Mn_{z}O₂ (x>0, y>0, z>0, and 0.8<x+y+z<1.2) can be used, for example. Specifically, 0.1x<y<8x and 0.1x<z<8x are preferably satisfied, for example. It is preferable that x, y, and z satisfy x:y:z=1:1:1 or the neighborhood thereof, for example. Alternatively, it is preferable that x, y, and z satisfy x:y:z=5:2:3 or the neighborhood thereof, for example. Alternatively, it is preferable that x, y, and z satisfy x:y:z=8:1:1 or the neighborhood thereof, for example. Alternatively, it is preferable that x, y, and z satisfy x:y:z=9:0.5:0.5 or the neighborhood thereof, for example. Alternatively, it is preferable that x, y, and z satisfy x:y:z=6:2:2 or the neighborhood thereof, for example. Alternatively, it is preferable that x, y, and z satisfy x:y:z=1:4:1 or the neighborhood thereof, for example.

For a composite oxide used for the region 192, the descriptions of the region 191 and the region 193 can be referred to. For a composite oxide used for the region 194, the description of the region 193 can be referred to.

### Example 4 of Particle

Described as a specific example of the particle 190 is an example in which LCO is used for the core and NCM is used for the shell, i.e., an example in which a Li—Co oxide is used for the region 191 and a lithium composite oxide containing three kinds of transition metals, cobalt as the first transition metal, nickel as the second transition metal, and manganese as the third transition metal, is used for the region 193. In the case of the structure in which LCO is used for the core and NCM is used for the shell, the content of cobalt in the entire positive electrode active material can be low; thus, the overall price of the positive electrode active material can be lower than that of the positive electrode active material containing only LCO. Furthermore, in the case of the structure in which LCO is used for the core and NCM is used for the shell, sufficient discharge capacity can be ensured at a charge voltage within a range of higher than or equal to 4.5 V and lower than 4.8 V (vs. Li/Li⁺).

As the lithium composite oxide containing cobalt, nickel, and manganese, a NiCoMn-based material (also referred to as NCM) represented by LiNiₓCo_{y}Mn_{z}O₂ (x>0, y>0, z>0, and 0.8<x+y+z<1.2) can be used, for example. Specifically, 0.1x<y<8x and 0.1x<z<8x are preferably satisfied, for example. It is preferable that x, y, and z satisfy x:y:z=1:1:1 or the neighborhood thereof, for example. Alternatively, it is preferable that x, y, and z satisfy x:y:z=5:2:3 or the neighborhood thereof, for example. Alternatively, it is preferable that x, y, and z satisfy x:y:z=8:1:1 or the neighborhood thereof, for example. Alternatively, it is preferable that x, y, and z satisfy x:y:z=9:0.5:0.5 or the neighborhood thereof, for example. Alternatively, it is preferable that x, y, and z satisfy x:y:z=6:2:2 or the neighborhood thereof, for example. Alternatively, it is preferable that x, y, and z satisfy x:y:z=1:4:1 or the neighborhood thereof, for example.

For a composite oxide used for the region 192, the descriptions of the region 191 and the region 193 can be referred to. For a composite oxide used for the region 194, the description of the region 193 can be referred to.

Furthermore, the region 193 may have a plurality of regions. For example, the region 193a and the region 193b may be included as illustrated in FIG. 1C. In that case, the concentration of at least one of the transition metals preferably differs between the region 193a and the region 193b.

For example, it is preferable that x, y, and z in the region 193a satisfy x:y:z=1:1:1 or the neighborhood thereof and x, y, and z in the region 193b satisfy x:y:z=8:1:1 or the neighborhood thereof. Alternatively, it is preferable that x, y, and z in the region 193a satisfy x:y:z=1:1:1 or the neighborhood thereof and x, y, and z in the region 193b satisfy x:y:z=9:0.5:0.5 or the neighborhood thereof.

Alternatively, it is further preferable that x, y, and z in the region 193a satisfy x:y:z=8:1:1 or the neighborhood thereof and x, y, and z in the region 193b satisfy x:y:z=1:1:1 or the neighborhood thereof. Alternatively, it is further preferable that x, y, and z in the region 193a satisfy x:y:z=9:0.5:0.5 or the neighborhood thereof and x, y, and z in the region 193b satisfy x:y:z=1:1:1 or the neighborhood thereof.

Here, the area of the region 193a is referred to as S₁₉₃ₐ, the area of the region 193b is referred to as S_{193b}, and S₁₉₃=S₁₉₃ₐ+S_{193b} is satisfied, as illustrated in FIG. 2C.

### Example 5 of Particle

Described as a specific example of the particle 190 is an example in which LCO is used for the core and LFP (lithium iron phosphate) is used for the shell, i.e., an example in which a Li—Co oxide is used for the region 191 and Li-iron phosphate (LiFePO₄) is used for the region 193.

Without being limited to LiFePO₄, another positive electrode material having an olivine crystal structure can be used for the region 193. Since a polyanionic skeleton formed of phosphorus and oxygen is stable in the olivine crystal structure even in a state where lithium is completely released, the crystal structure is less likely to collapse. Accordingly, a composite oxide having an olivine crystal structure is suitable for the region 193 serving as the shell. However, in the case where composite oxides having different crystal structures are used for the region 191 and the region 193, the region 192 preferably has a function of a buffer layer and a function of promoting grain boundary diffusion of lithium. Alternatively, the region 192 preferably has a function of strengthening the physical bond between the region 191 and the region 193. For a composite oxide used for the region 192, the descriptions of the region 191 and the region 193 can be referred to. For a composite oxide used for the region 194, the description of the region 193 can be referred to.

### Example 6 of Particle

Described as a specific example of the particle 190 is an example in which the first NCM is used for the core and the second NCM is used for the shell, i.e., an example in which a lithium composite oxide containing three kinds of transition metals, cobalt as the first transition metal, nickel as the second transition metal, and manganese as the third transition metal, is used for the region 191 and a lithium composite oxide containing three kinds of transition metals, cobalt as the first transition metal, nickel as the second transition metal, and manganese as the third transition metal is used for the region 193.

A LiNiₓCo_{y}Mn_{z}O₂ composite oxide represented by x:y:z=8:1:1 or x:y:z=9:0.5:0.5 can be used as the first NCM, and a LiNiₓCo_{y}Mn_{z}O₂ composite oxide represented by x:y:z=1:1:1 can be used as the second NCM. Note that the atomic ratio of the second NCM is not limited to the above. For example, when a nickel proportion is lower than that of the first NCM, an effect similar to that of the case of the above atomic ratio is obtained in some cases.

For a composite oxide used for the region 192, the descriptions of the region 191 and the region 193 can be referred to. For a composite oxide used for the region 194, the description of the region 193 can be referred to.

### Example 7 of Particle

Described as a specific example of the particle 190 is an example in which a lithium-excess positive electrode material is used for the region 191 and a Li—Co oxide is used for the region 193.

As the lithium-excess material, for example, Li₂MnO₂, Li₂MnO₃, Li₄Mn₂O₅, Li₅FeO₄, Li₃NbO₄, Li_{1.2}Ni_{0.2}Mn_{0.6}O₂, Li_{1.16}Ni_{0.15}Co_{0.19}Mn_{0.50}O₂, or a solid solution thereof can be used. These lithium-excess materials are preferable because discharge capacity per transition metal and that per weight are high. However, in the case where high voltage charge is performed or in the case where a charge depth is high in the above materials, oxygen release, dissolution of a transition metal, or cation mixing might easily occur. Accordingly, it is further preferable that materials inhibiting collapse of a crystal structure even when high voltage charge is performed be used in combination for the shell.

For a composite oxide used for the region 192, the descriptions of the region 191 and the region 193 can be referred to. For a composite oxide used for the region 194, the description of the region 193 can be referred to.

It is preferable that crystal orientations in the region 191 and the region 192 be substantially aligned with each other. Similarly, it is preferable that crystal orientations in the region 192 and the region 193 be substantially aligned with each other. Similarly, it is preferable that, in the case where the region 194 is included, crystal orientations in the region 193 and the region 194 be substantially aligned with each other. Similarly, it is preferable that, in the case where the region 193a and the region 193b are included, crystal orientations in the region 193a and the region 193b be substantially aligned with each other.

The crystal orientations are preferably substantially aligned with each other because a favorable lithium diffusion path can be secured and a secondary battery with favorable rate performance or charge and discharge characteristics can be obtained. In the case where the ion radius slightly differs between the composite oxides for the region 191 and the region 193, the region 192 preferably has a function of a buffer layer.

Here, charge refers to transfer of electrons from a positive electrode to a negative electrode in an external circuit. That is, in the case of charge, lithium ions are extracted from the positive electrode active material. With use of a positive electrode active material with a layered crystal structure typified by the above-described composite oxide containing lithium and the transition metal, a secondary battery with a large amount of lithium per volume and high capacity per volume can be provided in some cases. In such a positive electrode active material, the amount of lithium extracted during charge per volume is large; thus, in order to perform stable charge and discharge, the crystal structure after the extraction needs to be stabilized. Collapse of the crystal structure in charge and discharge may hinder fast charge and fast discharge. Furthermore, collapse of the crystal structure may reduce a region where lithium can be normally inserted and extracted, leading to decrease in charge capacity and discharge capacity.

When nickel is contained as the transition metal in addition to cobalt, a shift in a layered structure formed of octahedrons of cobalt and oxygen is sometimes inhibited. This is preferable because the crystal structure becomes more stable particularly in a high-temperature charged state in some cases.

In the case where nickel is contained as the transition metal in addition to cobalt, high nickel concentration enables inhibition of the shift in the layered structure due to extraction of lithium in some cases. Thus, charge and discharge can be repeated stably even when a large amount of lithium is extracted, in some cases. In other words, capacity can be increased.

On the other hand, in the case where nickel is contained as the transition metal in addition to cobalt, high nickel concentration causes easy collapse of the crystal structure at high charge voltages in some cases. This is because, since a lithium ion and a nickel ion have similar ion radii, cation mixing in which nickel moves into a lithium site easily occurs. In other words, it is preferable that the nickel concentration be not too high in order that high voltage charge may be performed.

### <Region Containing Element X and Halogen>

Each of the region 192 and the region 194 is preferably a region containing an element X and halogen. The element X and halogen are expressed as impurity elements in some cases.

The element X is one or more selected from titanium, magnesium, aluminum, zirconium, vanadium, iron, chromium, niobium, cobalt, arsenic, zinc, silicon, sulfur, phosphorus, boron, calcium, gallium, and silicon. The element X is preferably one or more elements including magnesium. It is preferable that one or more of fluorine and chlorine be contained as halogen, and it is particularly preferable that fluorine be contained.

A region in which the element X and halogen are added to a composite oxide represented by LiMO₂ can be used as the region containing the element X and halogen. Here, the composite oxide needs to have a crystal structure of the composite oxide represented by LiMO₂, but the composition is not strictly limited to Li:M:O=1:1:2.

When the composite oxide represented by LiMO₂ contains the element X and halogen, the crystal structure becomes more stable in some cases.

It is particularly preferable that magnesium be used as the element X It is particularly preferable that fluorine be used as halogen. The region containing the element X and halogen may contain lithium cobalt oxide to which magnesium and fluorine are added, lithium cobalt oxide to which magnesium, fluorine, and titanium are added, nickel-lithium cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the additive may be rephrased as a mixture, a constituent of a raw material, an impurity, or the like.

The region containing the element X and halogen may be a region including a bond between oxygen and the element X, for example. The bond between oxygen and the element X can be analyzed by XPS analysis, for example. The region containing the element X and halogen may contain magnesium oxide.

The region containing the element X and halogen may include a plurality of the regions given above as examples. An element, a crystal structure, a bond, or the like may differ between the region 192 and the region 194.

In the particle 190, the surface portion containing the element X and halogen, that is, the region 194 serving as an outer portion of the particle, and the region 192 positioned between the region 191 containing a composite oxide and the region 193 containing a composite oxide reinforce the particle 190 such that the layered structure of the composite oxide is not collapsed even when a metal serving as a carrier ion is released from the composite oxide by charging.

Hereinafter, the case where the region in which the element X and halogen are added to the composite oxide represented by LiMO₂ is used as the region containing the element X and halogen is considered.

Magnesium, which is an example of the element X, is divalent and is more stable in lithium sites than in transition metal sites in the layered rock-salt crystal structure; thus, magnesium is likely to enter the lithium sites. An appropriate concentration of magnesium in the lithium sites of the region containing the element X and halogen facilitates maintenance of the layered rock-salt crystal structure. An appropriate concentration of magnesium does not have an adverse effect on insertion or extraction of lithium in charge and discharge, and is thus preferable. However, excess magnesium might adversely affect insertion and extraction of lithium.

Aluminum, which is an example of the element X, is trivalent and has a high bonding strength with oxygen. Thus, when aluminum is contained as an additive and enters the lithium sites, a change in the crystal structure can be inhibited. Hence, the particle 190 can have the crystal structure that is unlikely to be collapsed by repeated charge and discharge.

A titanium oxide is known to have superhydrophilicity. Accordingly, when the region containing the element X and halogen contains a titanium oxide, good wettability with respect to a high-polarity solvent might be exhibited. In that case, the particle 190 and a high-polarity electrolyte solution can have favorable contact at the interface therebetween and presumably inhibit an internal resistance increase when a secondary battery is formed. In a titanium oxide, lithium is easily diffused and oxygen is less likely to be released during charge and discharge. For these reasons, titanium is particularly suitable for the element X.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a charge and discharge capacity decrease due to repeated charge and discharge.

A short circuit of a secondary battery might cause not only malfunction in charge operation and discharge operation of the secondary battery but also heat generation and firing. In order to obtain a safe secondary battery, a short-circuit current is preferably inhibited even at a high charge voltage. In the positive electrode active material of one embodiment of the present invention, a short-circuit current is inhibited even at a high charge voltage. Thus, a secondary battery having both high charge and discharge capacity and a high level of safety can be obtained.

It is preferable that a secondary battery using the positive electrode active material of one embodiment of the present invention can have high charge and discharge capacity, excellent charge and discharge cycle performance, and safety simultaneously.

### <Grain Boundary or the Like>

In the particle of one embodiment of the present invention (the region 191, the region 192, and the region 193), each or one of the region 191, the region 192, and the region 193 may be polycrystalline. The element X or halogen contained in the particle of one embodiment of the present invention (the region 191, the region 192, and the region 193) may randomly exist in a slight amount in an inner region, but is further preferably distributed unevenly at a grain boundary. Note that the element X in this case is preferably magnesium or titanium.

In other words, the magnesium concentration at the crystal grain boundary of the crystal included in the particle of one embodiment of the present invention and the vicinity thereof is preferably higher than that in the other regions in the inner region. In addition, the halogen concentration at the crystal grain boundary and the vicinity thereof is preferably higher than that in the other regions in the inner region.

The crystal grain boundary is a type of plane defect. Thus, the crystal grain boundary tends to be unstable and the crystal structure easily starts to change like the surface of the particle. Thus, the higher the magnesium concentration at the crystal grain boundary and the vicinity thereof is, the more effectively the change in the crystal structure can be reduced.

When the concentration of the element X and the halogen concentration are high at the crystal grain boundary and the vicinity thereof, the concentration of the element X and the halogen concentration in the vicinity of a surface generated by a crack are high even when the crack is generated along the crystal grain boundary of the particle of one embodiment of the present invention. Thus, the positive electrode active material can have an increased corrosion resistance to hydrofluoric acid even after a crack is generated.

Note that in this specification and the like, the vicinity of the crystal grain boundary refers to a region of approximately 10 nm from the grain boundary.

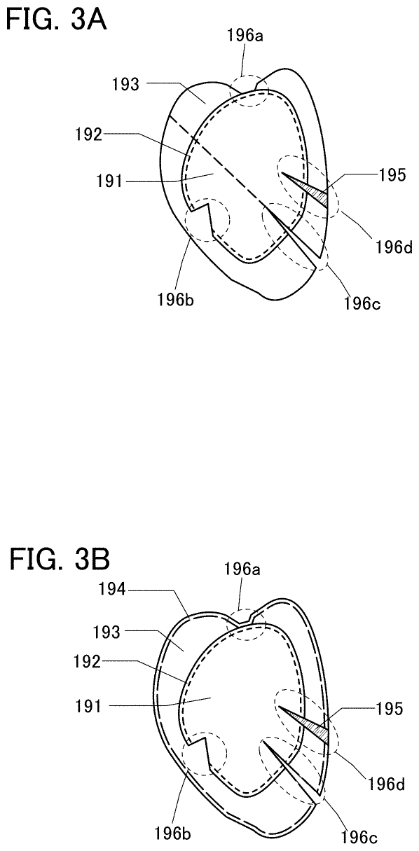

The particle 190 may include a defect, a crack, unevenness, cracking, or the like in addition to the grain boundary. Furthermore, a portion that lacks the region 192, the region 193, and the region 194 may be included. For example, as illustrated in a region 196a in each of FIG. 3A and FIG. 3B, a portion where there is no region 193 and the region 192 appears at the surface, or a portion where the region 194 is in contact with the region 192 may be included.

As illustrated in a region 196b in each of FIG. 3A and FIG. 3B, a portion where there is no region 192 and the region 191 is in contact with the region 193 may be included.

As illustrated in a region 196c in each of FIG. 3A and FIG. 3B, a portion where there is no region 194, region 193, nor region 192 and the region 191 appears at the surface may be included.

As illustrated in a region 196d in each of FIG. 3A and FIG. 3B, a region 195 having a composition different from those of other regions may be included at a defect, a crack, an uneven portion, cracking, a grain boundary, or the like. The region 195 is a region having an element, a composition, or a crystal structure different from those of the region 191 to the region 194.

Owing to the region 195, excess impurity elements are segregated by the region 195 so that impurity elements contained in the region 191 to the region 194 are kept in a favorable range, in some cases. Accordingly, owing to the region 195, a secondary battery with favorable rate performance or charge and discharge characteristics can be obtained in some cases.

The above regions can be determined to be different regions by any of or a combination of various analyses. Examples of the analyses include an electron microscope image obtained by TEM, STEM, HAADF-STEM, ABF-STEM, or the like; SIMS; ToF-SIMS; a diffraction pattern obtained by X-ray diffraction (XRD), electron diffraction, neutron diffraction, or the like; an electron probe microanalyzer (EPMA); and energy dispersive X-ray analysis (EDX). In a cross-sectional TEM image and STEM image of the particle 190, for example, a difference of constituent elements is observed as a difference of image brightness in some cases.

The boundary between the above regions is not clear in some cases. A concentration gradient of an element may be found between adjacent regions. The concentration of an element may be continuously changed. The concentration of an element may be gradually changed. Alternatively, gradation in the concentration of an element may be found. In that case, a boundary between regions can be, for example, a portion where the concentration of an element specific to either of the regions is 50%.

### <Shape of Particle>

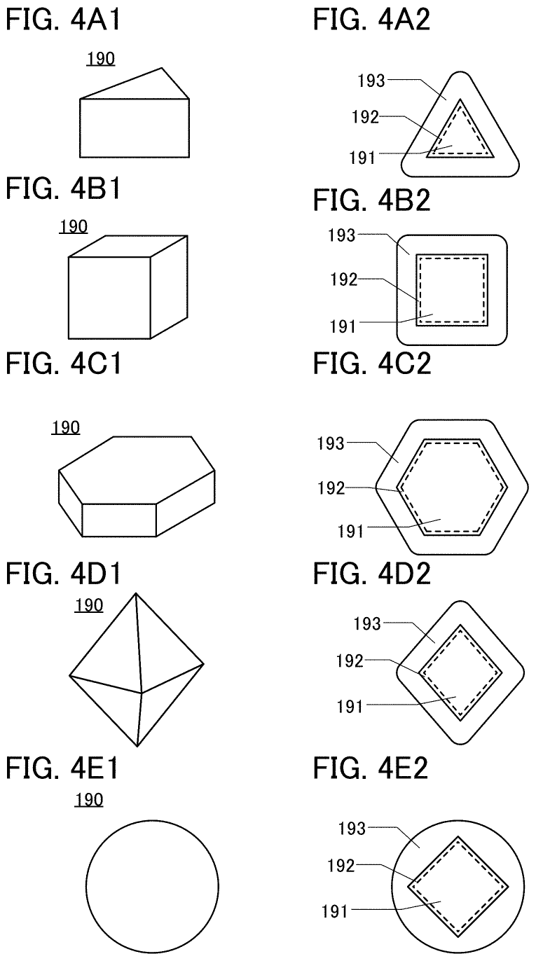

Note that the shape of the particle 190 is not limited to the shapes illustrated in FIG. 1 to FIG. 3. FIG. 4A1 is a perspective view of the particle 190, and FIG. 4A2 is a cross-sectional view of FIG. 4A1, for example. As illustrated therein, the particle 190 may have a triangular prism shape.

FIG. 4B1 is a perspective view of the particle 190, and FIG. 4B2 is a cross-sectional view of FIG. 4B1. As illustrated therein, the particle 190 may have a cube (dice) or rectangular solid shape.

FIG. 4C1 is a perspective view of the particle 190, and FIG. 4C2 is a cross-sectional view of FIG. 4C1. As illustrated therein, the particle 190 may have a hexagonal prism shape.

FIG. 4D1 is a perspective view of the particle 190, and FIG. 4D2 is a cross-sectional view of FIG. 4D1. As illustrated therein, the particle 190 may have an octahedral shape.

FIG. 4E1 is a perspective view of the particle 190, and FIG. 4E2 is a cross-sectional view of FIG. 4E1. As illustrated therein, the exterior shape of the particle 190 and the shapes of the region 191 and the region 192 may be different from each other.

### <Method for Forming Particle>

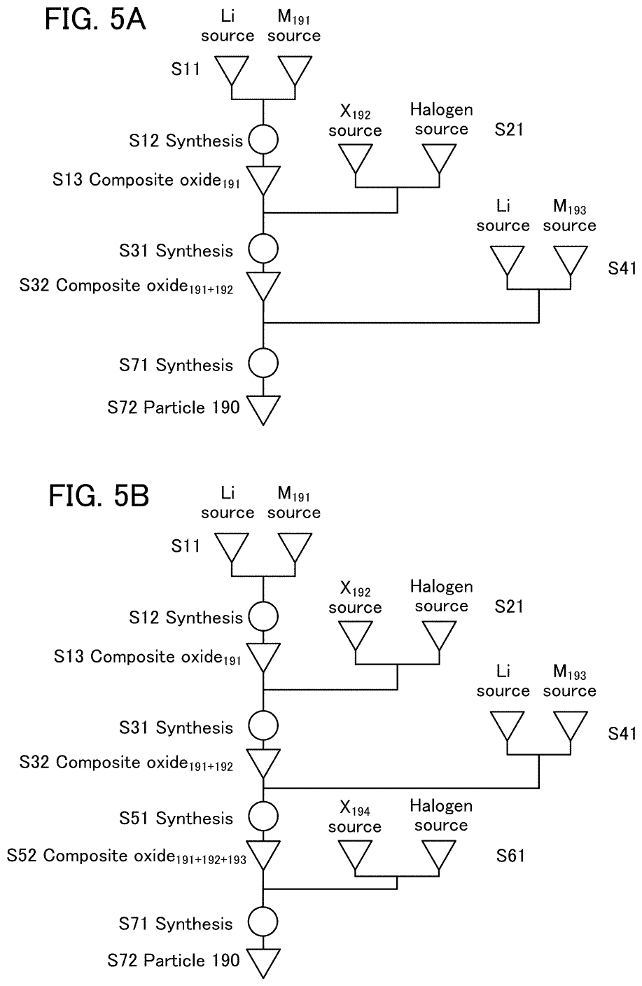

Next, a method for forming the particle 190 having the region 191 to the region 193 will be described with reference to FIG. 5A.

First, in Step S11, a lithium source and a transition metal M₁₉₁ source for the region 191 are prepared.

Next, in Step S12, synthesis is performed using the lithium source and the transition metal M₁₉₁ source for the region 191. As an example of the synthesis method, a method in which the lithium source and the transition metal source for the region 191 are mixed by a solid phase method and then heating is performed can be given.

In the above manner, a composite oxide C₁₉₁ contained in the region 191 is formed (Step S13).

Next, in Step S21, an X₁₉₂ source for the region 192 and a halogen source for the region 192 are prepared.

Next, in Step S31, synthesis is performed using the composite oxide C₁₉₁ contained in the region 191, the X₁₉₂ source for the region 192, and the halogen source for the region 192. As an example of the synthesis method, a method in which the materials are mixed by a solid phase method and then heating is performed can be given.

In the above manner, a composite oxide C₁₉₁₊₁₉₂ contained in the region 191 and the region 192 is formed (Step S32).

Next, in Step S41, a lithium source and a transition metal M₁₉₃ source for the region 193 are prepared.

Next, in Step S71, synthesis is performed using the composite oxide C₁₉₁₊₁₉₂ contained in the region 191 and the region 192, the lithium source, and the transition metal source M₁₉₃ for the region 193. As an example of the synthesis method, a method in which the materials are mixed by a solid phase method and then heating is performed can be given.

In the above manner, the particle 190 is formed (Step S72).

Note that the composite oxide C₁₉₁ contained in the region 191 is preferably a material having a higher melting point than a composite oxide C₁₉₃ contained in the region 193. Alternatively, the composite oxide C₁₉₁ contained in the region 191 is preferably a material having higher thermal stability than the composite oxide C₁₉₃ contained in the region 193. Owing to the difference in melting point or thermal stability, the temperature and time for the heating performed in the synthesis in Step S71 can be set such that interdiffusion of the composite oxide C₁₉₃ contained in the region 193 sufficiently occurs while the composite oxide C₁₉₁ contained in the region 191 is kept stable, for example.

The ion radius of a cation of the element X₁₉₂ contained in the region 192 is preferably larger than the ion radius of a cation contained in the region 191. The difference in ion radius leads to easy uneven distribution of the element X₁₉₂ in the region 192. Furthermore, the region 192 easily performs its function of inhibiting interdiffusion of elements in the region 191 and the region 193.

The particle 190 having the region 191 to the region 194 can be formed as illustrated in FIG. 5B, for example.

Step S11 to Step S41 can be similar to those in FIG. 5A.

Next, in Step S51, synthesis is performed using the composite oxide C₁₉₁₊₁₉₂ contained in the region 191 and the region 192, the lithium source, and the transition metal M₁₉₃ source contained in the region 193. As an example of the synthesis method, a method in which the materials are mixed by a solid phase method and then heating is performed can be given.

In the above manner, a composite oxide C₁₉₁₊₁₉₂₊₁₉₃ contained in the region 191 to the region 193 is formed (Step S52).

Next, in Step S61, an X₁₉₄ source for the region 194 and a halogen source for the region 194 are prepared.

Next, in Step S71, synthesis is performed using the composite oxide C₁₉₁₊₁₉₂₊₁₉₃ contained in the region 191 to the region 193, the X₁₉₄ source for the region 194, and the halogen source for the region 194. As an example of the synthesis method, a method in which the materials are mixed by a solid phase method and then heating is performed can be given.

In the above manner, the particle 190 is formed (Step S72).

The ion radius of a cation of the element X₁₉₄ contained in the region 194 is preferably larger than the ion radius of a cation contained in the region 193. The difference in ion radius leads to easy uneven distribution of the element X in the region 194.

This embodiment can be used in combination with the other embodiments.

### Embodiment 2

In this embodiment, an example of a material used for the region 191 (core) or the region 193 (shell) illustrated in FIG. 1A is described. A material having a layered rock-salt crystal structure, such as lithium cobalt oxide (LiCoO₂), is preferably used for the region 191 or the region 193 because the material has high discharge capacity and excels as a positive electrode active material of a secondary battery.

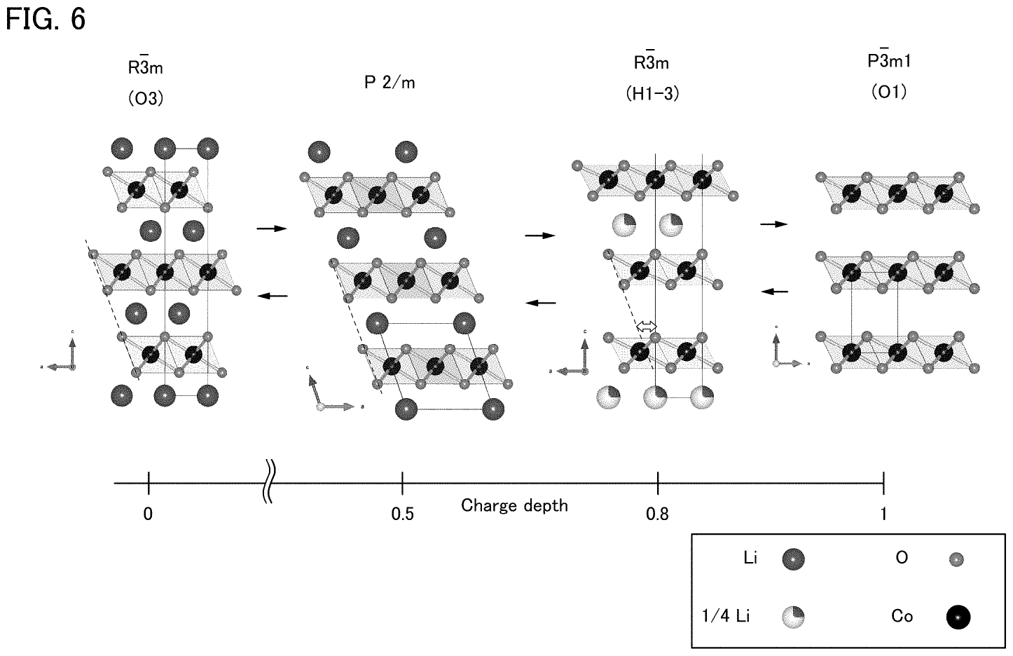

As an example of the material with a layered rock-salt crystal structure, a composite oxide represented by LiMO₂ is given. Note that in this specification and the like, a lithium composite oxide represented by LiMO₂ has a layered rock-salt crystal structure, and the composition is not strictly limited to Li:M:O=1:1:2. With FIG. 6, the case where cobalt is used as a transition metal M contained in the positive electrode active material is described.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charge and discharge with a high voltage are performed on LiNiO₂, the crystal structure might be broken because of the distortion. The influence of the Jahn-Teller effect is suggested to be small in LiCoO₂; hence, LiCoO₂ is preferable because the tolerance at the time of high voltage charge is higher in some cases.

A positive electrode active material illustrated in FIG. 6 is lithium cobalt oxide (LiCoO₂) to which either halogen or magnesium is not added in a formation method described later. The crystal structure of the lithium cobalt oxide illustrated in FIG. 6 is changed depending on a charge depth.

As illustrated in FIG. 6, in lithium cobalt oxide with a charge depth of 0 (discharged state), there is a region having a crystal structure belonging to the space group R-3m, and a unit cell includes three CoO₂ layers. Thus, this crystal structure is referred to as an O3 type crystal structure in some cases. Note that, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3m1 and includes one CoO₂ layer in a unit cell. Hence, this crystal structure is referred to as an O1 type crystal structure in some cases.

Lithium cobalt oxide with a charge depth of approximately 0.88 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 6, and other drawings, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygen.

Although lithium cobalt oxide (LiCoO₂) is described as an example of a material used for the core or the shell here, the material is not particularly limited to the example.

Examples of materials that can be used for the region 193 and the region 194 illustrated in FIG. 1B are described below. A material used for at least one of the region 191 and the region 192 illustrated in FIG. 1B preferably contains lithium, cobalt as the transition metal M, oxygen, and magnesium. Furthermore, an impurity in the region 192 and the region 194 preferably includes halogen such as fluorine or chlorine. It is further preferable that the material have an O3′ type crystal structure at the time of charge.

In the case where magnesium and fluorine are added to lithium cobalt oxide (LiCoO₂), the crystal structure with a charge depth of 0 (in a discharged state) is R-3m (O3), but with a sufficiently charged charge depth, lithium cobalt oxide has a crystal with a structure different from the H1-3 type crystal structure. This structure belongs to the space group R-3m and is a structure in which an ion of cobalt, magnesium, or the like occupies a site coordinated to six oxygen atoms. Furthermore, the symmetry of CoO₂ layers of this structure is the same as that in the O3 type structure. Accordingly, this structure is referred to as an O3′ type crystal structure in this specification and the like. In both the O3 type crystal structure and the O3′ type crystal structure, a slight amount of magnesium preferably exists between the CoO₂ layers, i.e., in lithium sites. In addition, a slight amount of fluorine preferably exists at random in oxygen sites.

The O3′ type crystal structure is preferably represented by a unit cell including one cobalt and one oxygen. This means that the symmetry of cobalt and oxygen differs between the O3′ structure and the H1-3 type crystal structure, and the amount of change from the O3 structure is smaller in the O3′ structure than in the H1-3 type crystal structure. A preferred unit cell for representing a crystal structure in a positive electrode active material is selected such that the value of GOF (goodness of fit) is smaller in the Rietveld analysis of XRD, for example.

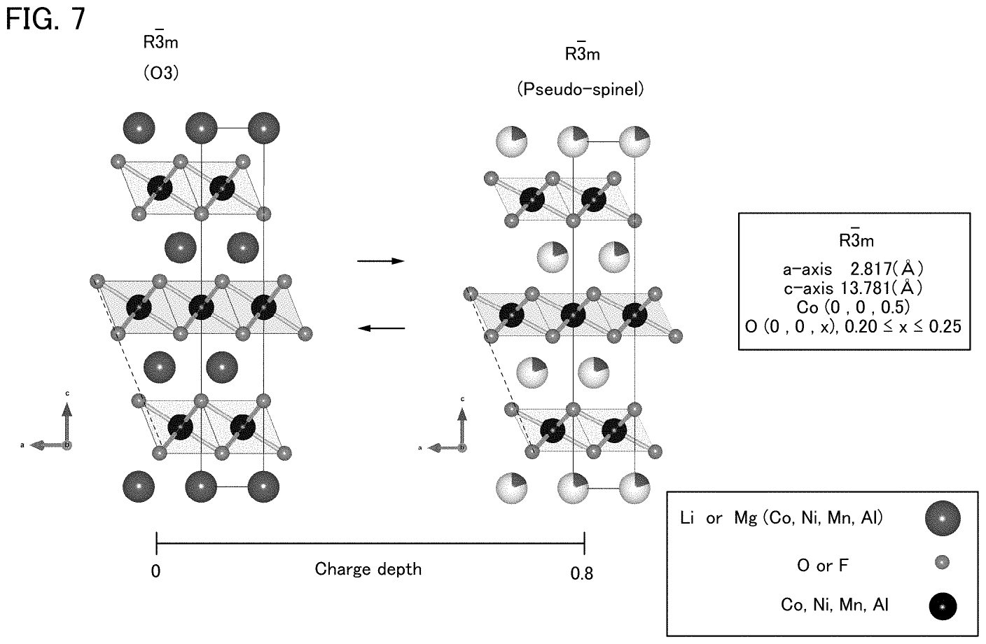

Although FIG. 7 illustrates a crystal structure of a positive electrode active material in which a chance of the existence of lithium is the same in all lithium sites, the O3′ structure is not limited the structure. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example.

In the positive electrode active material having the O3′ type crystal structure illustrated in FIG. 7, a crystal structure change caused when a large amount of lithium is extracted by charge with a high voltage is smaller than that in the positive electrode active material in FIG. 6. As denoted by the dotted lines in FIG. 7, for example, the CoO₂ layers hardly shift between the crystal structures.

Specifically, in the positive electrode active material having the crystal structure illustrated in FIG. 7, the structure is highly stable even when charge voltage is high. For example, at a charge voltage that makes a positive electrode active material in FIG. 7 have the H1-3 type crystal structure, for example, at a voltage of approximately 4.6 V with reference to the potential of a lithium metal, the crystal structure belonging to R-3m (O3) can be maintained. Moreover, in a higher charge voltage region, for example, at voltages of approximately 4.65 V to 4.7 V with reference to the potential of a lithium metal, there is a region within which the O3′ type crystal structure can be obtained. At a much higher charge voltage, the H1-3 type crystal is eventually observed in some cases. Note that in the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V; in a higher charge voltage region, for example, at a voltage higher than or equal to 4.35 V and lower than or equal to 4.55 V with reference to the potential of a lithium metal, there is a region within which the O3′ type crystal structure can be obtained.

Accordingly, in the positive electrode active material having the crystal structure illustrated in FIG. 7, the crystal structure is unlikely to be broken even when charge and discharge with a high voltage are repeated; thus, the positive electrode active material is suitable for a shell.

Note that in the unit cell of the O3′ type crystal structure, the coordinates of cobalt and oxygen can be represented by Co (0, 0, 0.5) and 0 (0, 0, x) within the range of 0.20×0.25.

A slight amount of the added element such as magnesium randomly existing between the CoO₂ layers, i.e., in lithium sites, can suppress a shift in the CoO₂ layers at the time of charge with a high voltage. Thus, magnesium between the CoO₂ layers makes it easier to obtain the O3′ type crystal structure. Therefore, magnesium is preferably distributed throughout a particle of the positive electrode active material having the crystal structure illustrated in FIG. 7. To distribute magnesium throughout the particle, heat treatment is preferably performed in the formation process of the positive electrode active material.

However, heat treatment at an excessively high temperature may cause cation mixing, which increases the possibility of entry of the added element such as magnesium into the cobalt sites. Magnesium in the cobalt sites eliminates the effect of maintaining the R-3m structure at the time of high voltage charge. Furthermore, heat treatment at an excessively high temperature might have an adverse effect; for example, cobalt might be reduced to have a valence of two or lithium might be evaporated.

In view of the above, a material serving as a flux is preferably added to lithium cobalt oxide before the heat treatment for distributing magnesium throughout the particle. This decreases the melting point. The decreased melting point makes it easier to distribute magnesium throughout the particle at a temperature at which the cation mixing is unlikely to occur. Furthermore, when the material serving as a flux contains fluorine, an increase in corrosion resistance to hydrofluoric acid generated by decomposition of an electrolyte solution is expected.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material having the crystal structure shown in FIG. 7 is preferably greater than or equal to 0.001 times and less than or equal to 0.1 times, further preferably greater than 0.01 and less than 0.04, still further preferably approximately 0.02 the number of atoms of the transition metal M. Alternatively, the number of magnesium atoms in the positive electrode active material having the crystal structure shown in FIG. 7 is preferably greater than or equal to 0.001 times and less than 0.04 or greater than or equal to 0.01 and less than or equal to 0.1 the number of atoms of the transition metal M. The magnesium concentration described here may be a value obtained by element analysis on the whole particles of the positive electrode active material using ICP-MS or the like, or may be a value based on the ratio of the raw materials mixed in the process of forming the positive electrode active material, for example.

As a metal other than cobalt (hereinafter, a metal Z), one or more metals selected from nickel, aluminum, manganese, titanium, vanadium, and chromium may be added to lithium cobalt oxide, for example, and in particular, at least one of nickel and aluminum is preferably added. In some cases, manganese, titanium, vanadium, and chromium are likely to have a valence of four stably and thus contribute highly to a stable structure. The addition of the metal Z may enable the positive electrode active material having the crystal structure shown in FIG. 7 to have a more stable crystal structure in high-voltage charged state, for example. Here, in the positive electrode active material having the crystal structure shown in FIG. 7, the metal Z is preferably added at a concentration that does not greatly change the crystallinity of the lithium cobalt oxide. For example, the metal Z is preferably added at an amount with which the aforementioned Jahn-Teller effect is not exhibited.

As shown in introductory remarks in FIG. 7, aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material having the crystal structure illustrated in FIG. 7 increases, the charge and discharge capacity of the positive electrode active material decreases in some cases. One possible reason is that, for example, the amount of lithium that contributes to charge and discharge decreases when magnesium enters the lithium sites. Another possible reason is that excess magnesium generates a magnesium compound that does not contribute to charge and discharge. When the positive electrode active material having the crystal structure illustrated in FIG. 7 contains nickel as a metal Z in addition to magnesium, the charge and discharge capacity per weight and per volume can be increased in some cases. When the positive electrode active material having the crystal structure illustrated in FIG. 7 contains aluminum as the metal Z in addition to magnesium, the charge and discharge capacity per weight and per volume can be increased in some cases. When the positive electrode active material having the crystal structure illustrated in FIG. 7 contains nickel and aluminum in addition to magnesium, the charge and discharge capacity per weight and per volume can be increased in some cases.

The preferable concentrations of the elements contained in the positive electrode active material having the crystal structure illustrated in FIG. 7, such as magnesium and the metal Z, are described below using the number of atoms.

The number of nickel atoms in the positive electrode active material having the crystal structure illustrated in FIG. 7 is preferably greater than 0% and less than or equal to 7.5%, further preferably greater than or equal to 0.05% and less than or equal to 4%, still further preferably greater than or equal to 0.1% and less than or equal to 2% of the number of cobalt atoms. Alternatively, the number of nickel atoms in the positive electrode active material having the crystal structure illustrated in FIG. 7 is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The nickel concentration described here may be a value obtained by element analysis on the whole particles of the positive electrode active material using ICP-MS or the like, or may be a value based on the ratio of the raw materials mixed in the process of forming the positive electrode active material, for example.

Nickel contained at any of the above concentrations easily forms a solid solution uniformly throughout the positive electrode active material having the crystal structure illustrated in FIG. 7 and thus particularly contributes to stabilization of the crystal structure of the inner portion 100b. When divalent nickel exists in the inner portion 100b, a slight amount of the added element having a valence of two and randomly existing in lithium sites, such as magnesium, might be able to exist more stably in the vicinity of the divalent nickel. Thus, even when charge and discharge with a high voltage are performed, dissolution of magnesium might be inhibited. Accordingly, charge and discharge cycle performance might be improved. Such a combination of the effect of nickel in the inner portion 100b and the effect of magnesium, aluminum, titanium, fluorine, or the like in the surface portion 100a extremely effectively stabilizes the crystal structure at the time of charge with a high voltage.

The number of aluminum atoms in the positive electrode active material having the crystal structure illustrated in FIG. 7 is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms in the positive electrode active material having the crystal structure illustrated in FIG. 7 is preferably greater than or equal to 0.05% and less than or equal to 2%, or greater than or equal to 0.1% and less than or equal to 4% of the number of cobalt atoms. The aluminum concentration described here may be a value obtained by element analysis on the whole particles of the positive electrode active material using GD-MS, ICP-MS, or the like, or may be a value based on the ratio of the raw materials mixed in the process of forming the positive electrode active material, for example.

When containing magnesium in addition to the element X, the positive electrode active material having the crystal structure illustrated in FIG. 7 is extremely stable in a high voltage charged state. When the element X is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the whole particles of the positive electrode active material using ICP-MS or the like, or may be a value based on the ratio of the raw materials mixed in the process of forming the positive electrode active material, for example.

A deviation in the CoO₂ layers can be small in repeated high-voltage charge and discharge. Furthermore, the change in the volume can be small. Thus, when the shell has the crystal structure illustrated in FIG. 7 in at least part thereof, excellent cycle performance can be obtained. Furthermore, when the shell has the crystal structure illustrated in FIG. 7, a crystal structure stable in a high-voltage charged state can be obtained. Thus, when the shell has the crystal structure illustrated in FIG. 7, a short circuit is less likely to occur while the high-voltage charged state is maintained, in some cases. This is preferable because the safety is further improved.

When the shell has the crystal structure illustrated in FIG. 7, a change in the crystal structure and a difference in volume per the same number of transition metal atoms between a sufficiently discharge state and a high-voltage charged state are small.

The space group of a crystal structure is identified by XRD, electron diffraction, neutron diffraction, or the like. Thus, in this specification and the like, belonging to a space group or being a space group can be rephrased as being identified as a space group.

This embodiment can be freely combined with the other embodiments.

### Embodiment 3

Since the particle 190 described in Embodiment 1 is used for fabricating a secondary battery, an example of a positive electrode to be fabricated is described below. The secondary battery at least includes an exterior body, a current collector, an active material (a positive electrode active material or a negative electrode active material), a conductive material, and a binder. The secondary battery also includes an electrolyte solution in which a lithium salt or the like is dissolved. In the case of the secondary battery including an electrolyte solution, a positive electrode, a negative electrode, and a separator between the positive electrode and the negative electrode are provided.

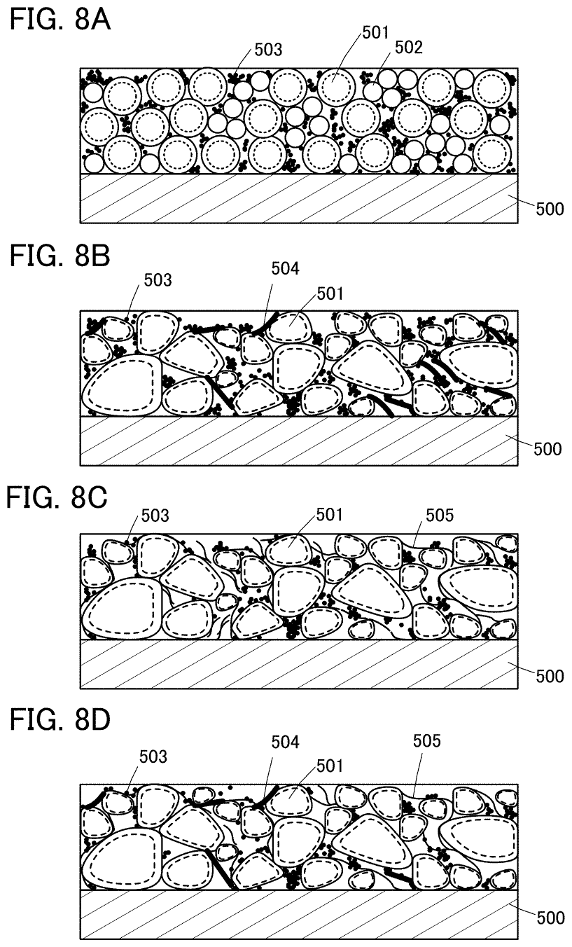

First, a positive electrode is described. FIG. 8A illustrates an example of a schematic cross-sectional view of the positive electrode.

A current collector 500 is metal foil, and the positive electrode is formed by applying a slurry onto the metal foil and drying the slurry. Pressing may be performed after drying. The positive electrode is obtained by forming an active material layer over the current collector 500.

A slurry refers to a material solution that is used to form an active material layer over the current collector 500 and includes at least an active material, a binder, and a solvent, preferably also a conductive material mixed therewith. The slurry may also be referred to as a slurry for an electrode or an active material slurry; in some cases, a slurry for a positive electrode is used to form a positive electrode active material layer, and a slurry is referred to as a slurry for a negative electrode when a negative electrode active material layer is formed.

The conductive material is also referred to as a conductivity-imparting agent and a conductive material, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Typical examples of the carbon material used as the conductive material include carbon black (e.g., furnace black, particulate carbon such as acetylene black, and graphite).

In FIG. 8A, an acetylene black 503 is illustrated as a conductive material. FIG. 8A illustrates an example in which a second active material 502 whose particle diameter is smaller than that of the particle 190 described in Embodiment 1 is mixed. A positive electrode with high density can be obtained when particles with different particle diameters are mixed. Note that the particle 190 described in Embodiment 1 corresponds to an active material 501 in FIG. 8A.

In the positive electrode of the secondary battery, a binder (a resin) is mixed in order to fix the current collector 500 such as metal foil and the active material. The binder is also referred to as a binding agent. Since the binder is a high-molecular material, the proportion of the active material in the positive electrode is lowered when a large amount of binder is contained, which reduces the discharge capacity of the secondary battery. Therefore, the minimum amount of binder is mixed. In FIG. 8A, regions not filled with any of the active material 501, the second active material 502, and the acetylene black 503 indicate spaces or binders.

In FIG. 8A, the boundary between a core region and a shell region of the active material 501 is indicated by a dotted line in the active material 501. Although FIG. 8A illustrates an example in which the active material 501 has a spherical shape, there is no particular limitation and other various shapes may be employed. The cross-sectional shape of the active material 501 may be an ellipse, a rectangle, a trapezoid, a cone, a quadrilateral with rounded corners, or an asymmetrical shape.

In FIG. 8B, the active material 501 is illustrated as various shapes. FIG. 8B illustrates an example different from FIG. 8A.

In the positive electrode in FIG. 8B, graphene 504 is used as a carbon material used as the conductive material.

Graphene, which has electrically, mechanically, or chemically marvelous characteristics, is a carbon material that is expected to be applied to a variety of fields, such as field-effect transistors or solar batteries.

In FIG. 8B, a positive electrode active material layer containing the active material 501, the graphene 504, and the acetylene black 503 is formed over the current collector 500. The graphene 504 is formed to partly coat the plurality of particles of the active material 501 or adhere to the surfaces of the plurality of particles of the active material 501, so that the graphene 504 makes surface contact with the particles of the active material 501. Note that the graphene 504 preferably clings to at least part of the active material 501. The graphene 504 preferably overlays at least part of the active material 501. The shape of the graphene 504 preferably conforms to at least part of the shape of the active material 501. The shape of the active material means, for example, unevenness of a single active material particle or unevenness formed by a plurality of active material particles. The graphene 504 preferably surrounds at least part of the active material 501. The graphene 504 may have a hole.

In a step of mixing the graphene 504 and the acetylene black 503 to obtain an electrode slurry, the weight of mixed carbon black is preferably 1.5 times or more and 20 times or less, further preferably 2 times or more and 9.5 times or less the weight of graphene.

When the graphene 504 and the acetylene black 503 are mixed in the above range, the acetylene black 503 can be dispersed uniformly and less likely to be aggregated at the time of preparing the slurry. Furthermore, when the graphene 504 and the acetylene black 503 are mixed in the above range, the positive electrode can have higher density than that using only the acetylene black 503 as the conductive material. As the electrode density is higher, the capacity per unit weight can be higher. Specifically, the density of the positive electrode active material layer obtained by gravimetry can be higher than 3.5 g/cc. In addition, it is preferable that the particle 190 described in Embodiment 1 be used for the positive electrode and the graphene 504 and the acetylene black 503 be mixed in the above range, in which case synergy for higher capacity of the secondary battery can be expected.

Mixing a first carbon material (graphene) and a second carbon material (acetylene black) in the above range enables a secondary battery to be fast-charged although the electrode density is lower than that of a positive electrode containing only graphene as a conductive material. In addition, it is preferable that the particle 190 described in Embodiment 1 be used for a positive electrode and the graphene 504 and the acetylene black 503 be mixed in the above range, in which case the stability of a secondary battery is increased and synergy for further fast charge can be expected.

These are advantageous for a secondary battery for a vehicle.

When a vehicle becomes heavier with increasing the number of secondary batteries, energy to move the vehicle increases, which makes the cruising range short. The use of a secondary battery with high density can maintain the cruising range with only a little change in the total weight of the vehicle including the secondary battery with the same weight.

Furthermore, when a secondary battery in a vehicle has high capacity, electric power needs to be charged; thus, it is desirable that charge be completed in a short time. What is called a regenerative charge, in which electric power temporarily generated when the vehicle is braked is used for charge, is performed under high rate charge conditions; thus, a secondary battery for a vehicle is desired to have favorable rate characteristics.

Using the particle 190 described in Embodiment 1 for the positive electrode and mixing acetylene black and graphene at a ratio within an optimal range enable both higher electrode density and formation of an appropriate space needed for ion conduction, whereby a secondary battery for a vehicle which has high energy density and favorable output characteristics can be obtained.

Furthermore, this structure is also effective in a portable information terminal: using the particle 190 described in Embodiment 1 for the positive electrode and mixing acetylene black and graphene at a ratio within an optimal range enable a secondary battery to have a small size and high capacity. In addition, acetylene black and graphene mixed at a ratio within an optimal range enable the portable information terminal to be fast-charged.

In FIG. 8B, the boundary between the core region and the shell region of the active material 501 is indicated by a dotted line in the active material 501. In FIG. 8B, regions not filled with any of the active material 501, the graphene 504, and the acetylene black 503 indicate spaces or binders. A space is required for penetration of the electrolyte solution; too many spaces lower the electrode density, whereas too few spaces do not allow penetration of the electrolyte solution, and a space that remains after the secondary battery is completed lowers the efficiency.

Using the particle 190 described in Embodiment 1 for the positive electrode and mixing acetylene black and graphene at a ratio within an optimal range enable both higher electrode density and formation of an appropriate space needed for ion conduction, whereby a secondary battery which has high energy density and favorable output characteristics can be obtained.

FIG. 8C illustrates an example of a positive electrode in which a carbon nanotube 505, which is an example of fibrous carbon, is used instead of graphene. FIG. 8C illustrates an example different from FIG. 8B. With the use of the carbon nanotube 505, aggregation of carbon black such as the acetylene black 503 can be prevented and the dispersibility can be increased.

In FIG. 8C, regions not filled with any of the active material 501, the carbon nanotube 505, and the acetylene black 503 indicate spaces or binders.

FIG. 8D illustrates another example of a positive electrode. In addition, in the example illustrated in FIG. 8C, the carbon nanotube 505 is used in addition to the graphene 504. With the use of both the graphene 504 and the carbon nanotube 505, aggregation of carbon black such as the acetylene black 503 can be prevented and the dispersibility can be further increased.

In FIG. 8D, regions not filled with any of the active material 501, the carbon nanotube 505, the graphene 504, and the acetylene black 503 indicate spaces or binders.

A secondary battery can be fabricated by using any one of the positive electrodes in FIG. 8A, FIG. 8B, FIG. 8C, and FIG. 8D; setting, in a container (e.g., an exterior body or a metal can), a stack in which a separator is provided over the positive electrode and a negative electrode is provided over the separator; and filling the container with an electrolyte solution.

Note that as the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, for example, a cellulose derivative such as carboxymethyl cellulose (CMC), methyl cellulose, ethyl cellulose, hydroxypropyl cellulose, diacetyl cellulose, or regenerated cellulose or starch can be used. It is further preferable that such water-soluble polymers be used in combination with the above rubber material.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group; because of functional groups, polymers are expected to interact with each other and cover an active material surface in a large area.

In the case where the binder that covers the active material surface or is in contact with the surface forms a film, the film is expected to serve also as a passivation film to inhibit the decomposition of an electrolyte. Here, a passivation film refers to a film without electric conductivity or a film with extremely low electric conductivity, and can inhibit the decomposition of an electrolyte at a battery reaction potential when the passivation film is formed on the active material surface, for example. It is further desirable that the passivation film can conduct lithium ions while inhibiting electrical conduction.

Although the above structure is an example of a secondary battery containing an electrolyte solution, one embodiment of the present invention is not limited thereto.

For example, a semi-solid-state battery or an all-solid-state battery can be fabricated using the particle 190 described in Embodiment 1.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery fabricated using the particle 190 described in Embodiment 1 is a secondary battery having high charge and discharge capacity. The semi-solid-state battery can have high charge and discharge voltage. A highly safe or reliable semi-solid-state battery can be achieved.

This embodiment can be freely combined with the other embodiments.

### Embodiment 4

In this embodiment, an example where an all-solid-state battery is fabricated using the particle 190 described in Embodiment 1 will be described.

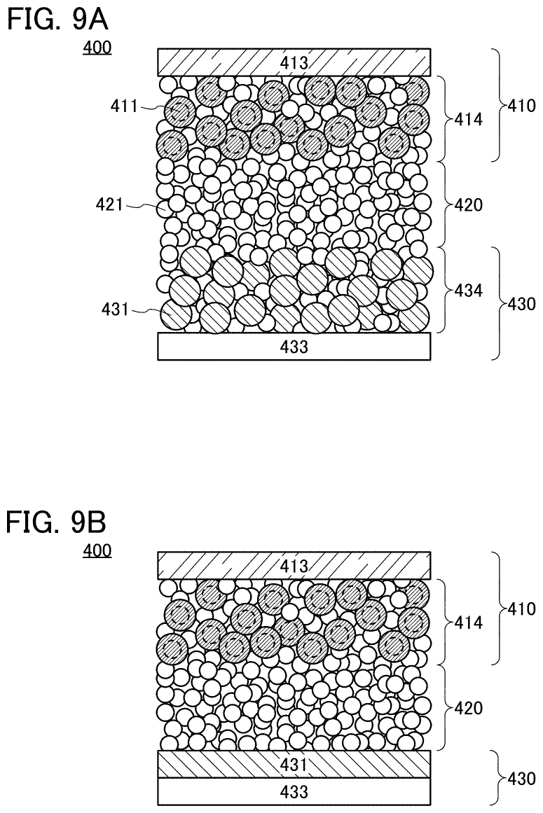

As illustrated in FIG. 9A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The particle 190 described in Embodiment 1 is used as the positive electrode active material 411, and a boundary between a core region and a shell region is indicated by a dotted line. The positive electrode active material layer 414 may include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder.

As a negative electrode active material, for example, an alloy-based material or a carbon-based material can be used.

For the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferable because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case the negative electrode active material contains lithium ions and thus can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

When metal lithium is used for the negative electrode 430, it is possible that the negative electrode 430 does not include the solid electrolyte 421 as illustrated in FIG. 9B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-silicon-based material (e.g., Li₁₀GeP₂S₁₂ or Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, or 50Li₂S.50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

The oxide-based solid electrolyte includes a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄.50Li₃BO₃), or oxide-based crystallized glass (e.g., Li_{0.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

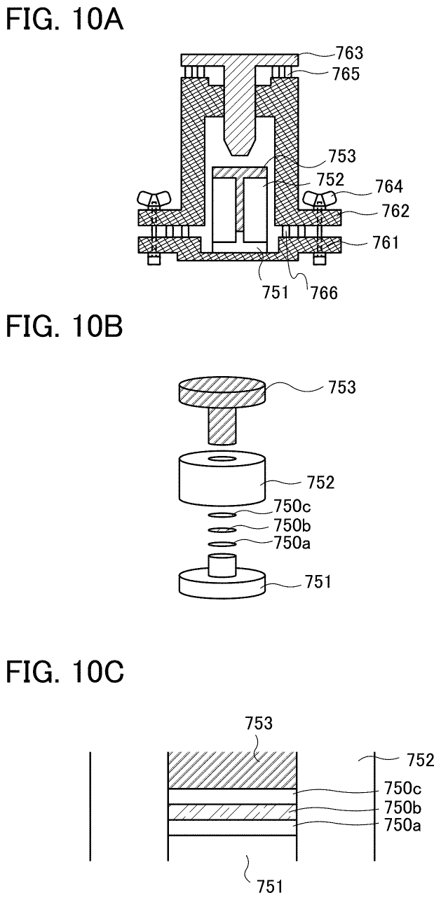

FIG. 10A to FIG. 10C illustrate an example of a cell for evaluating materials of an all-solid-state battery, for example.

FIG. 10A is a schematic cross-sectional view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 10B is an enlarged perspective view of the evaluation material and its vicinity.

A stack of a positive electrode 750a, a solid electrolyte layer 750b, and a negative electrode 750c is shown here as an example of the evaluation material, and its cross-sectional view is illustrated in FIG. 10C. Note that the same portions in FIG. 10A to FIG. 10C are denoted by the same reference numerals.

The electrode plate 751 and the lower component 761 that are electrically connected to the positive electrode 750a can be said to correspond to a positive electrode terminal. The electrode plate 753 and the upper component 762 that are electrically connected to the negative electrode 750c can be said to correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package and/or a resin package can be used. The exterior body is sealed preferably in a closed atmosphere where the outside air is blocked, for example, in a glove box.

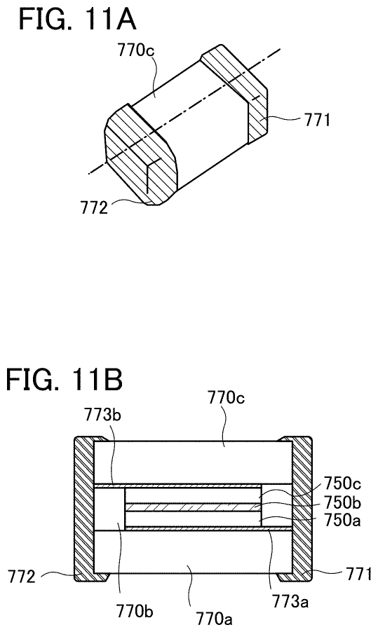

FIG. 11A illustrates a perspective view of a secondary battery of one embodiment of the present invention that has an exterior body and a shape different from those in FIG. 10A to FIG. 10C. The secondary battery in FIG. 11A includes external electrodes 771 and 772 and is sealed with an exterior body including a plurality of package components.

FIG. 11B illustrates an example of a cross section along the dashed-dotted line in FIG. 11A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and/or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the particle 190 described in Embodiment 1 can achieve an all-solid-state secondary battery having a high energy density and favorable output characteristics.

This embodiment can be used in appropriate combination with the other embodiments.

### Embodiment 5

In this embodiment, examples of a shape of a secondary battery including the positive electrode described in the above embodiment will be described. For the materials used for the secondary battery described in this embodiment, the description of the above embodiment can be referred to.

### <Coin-Type Secondary Battery>

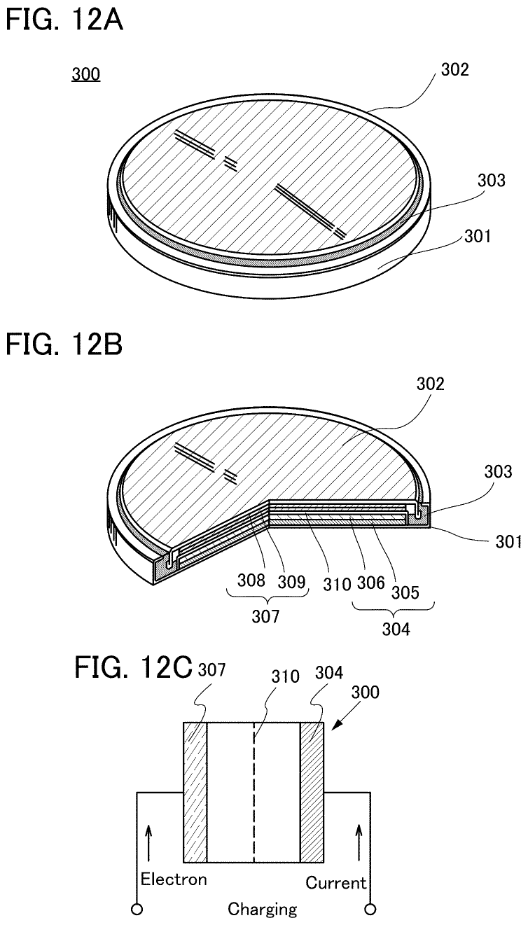

First, an example of a coin-type secondary battery is described. FIG. 12A is an external view of a coin-type (single-layer flat type) secondary battery, and FIG. 12B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 is formed of a positive electrode current collector 305 and a positive electrode active material layer 306 provided in contact with the positive electrode current collector 305. A negative electrode 307 is formed of a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with, for example, nickel and/or aluminum in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are soaked in the electrolyte solution, and as illustrated in FIG. 12B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween.

The particle 190 described in Embodiment 1 is used in the positive electrode 304, whereby the coin-type secondary battery 300 can have high charge and discharge capacity and excellent cycle performance.

Here, a current flow in charging a secondary battery is described with reference to FIG. 12C. When a secondary battery using lithium is regarded as a closed circuit, movement of lithium ions and the current flow are in the same direction. Note that in the secondary battery using lithium, the anode and the cathode interchange in charge and discharge, and an oxidation reaction and a reduction reaction interchange; hence, an electrode with a high reaction potential is called a positive electrode and an electrode with a low reaction potential is called a negative electrode. For this reason, in this specification, the positive electrode is referred to as a “positive electrode” or a “+ electrode (plus electrode)” and the negative electrode is referred to as a “negative electrode” or a “− electrode (minus electrode)” in all the cases where charge is performed, discharge is performed, a reverse pulse current is supplied, and a charge current is supplied. The use of the terms “anode” and “cathode” related to an oxidation reaction and a reduction reaction might cause confusion because the anode and the cathode interchange in charge and discharge. Thus, the terms “anode” and “cathode” are not used in this specification. If the term “anode” or “cathode” is used, whether it is at the time of charge or discharge is noted and whether it corresponds to a positive electrode (plus electrode) or a negative electrode (minus electrode) is also noted.

Two terminals illustrated in FIG. 12C are connected to a charger, and the secondary battery 300 is charged. As the charge of the secondary battery 300 proceeds, a potential difference between the electrodes increases.

<Secondary Battery with Stacked-Layer Structure>

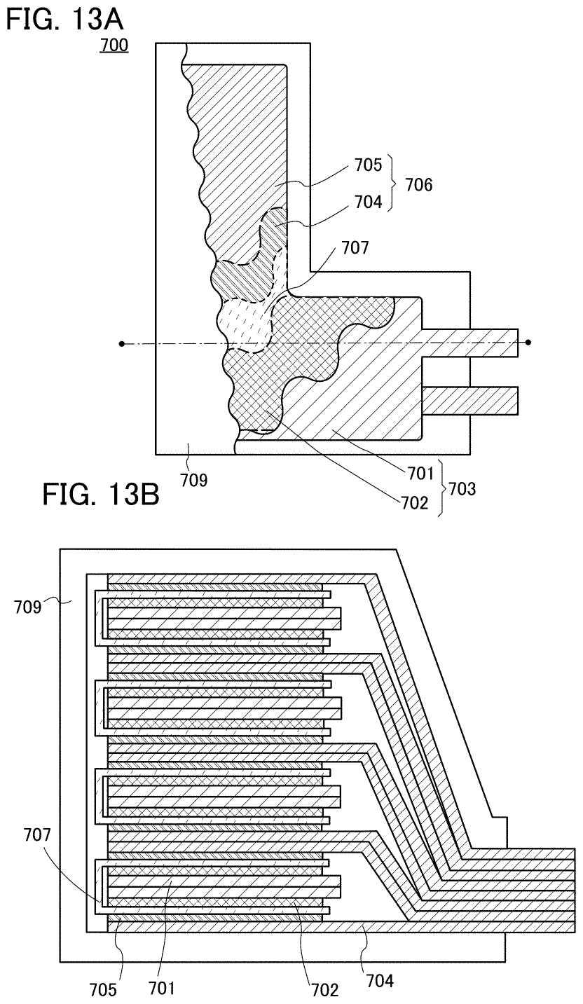

The secondary battery of one embodiment of the present invention may be a secondary battery 700 in which a plurality of electrodes are stacked, as illustrated in FIG. 13A and FIG. 13B. The electrodes and an exterior body are not limited to having L-shapes, and may have rectangular shapes.

The laminated secondary battery 700 illustrated in FIG. 13A includes a positive electrode 703 including a positive electrode current collector 701 and a positive electrode active material layer 702 that have L-shapes, a negative electrode 706 including a negative electrode current collector 704 and a negative electrode active material layer 705 that have L-shapes, an electrolyte layer 707, and an exterior body 709. The electrolyte layer 707 is placed between the positive electrode 703 and the negative electrode 706 provided in the exterior body 709.

In the laminated secondary battery 700 illustrated in FIG. 13A, the positive electrode current collector 701 and the negative electrode current collector 704 also serve as terminals for electrical contact with the outside. For this reason, portions of the positive electrode current collector 701 and the negative electrode current collector 704 may be placed to be exposed from the exterior body 709 to the outside. Alternatively, without exposing the positive electrode current collector 701 and the negative electrode current collector 704 from the exterior body 709 to the outside, a lead electrode may be used, and the lead electrode and the positive electrode current collector 701 or the negative electrode current collector 704 may be bonded by ultrasonic welding so that the lead electrode is exposed to the outside.

As the exterior body 709 of the laminated secondary battery, for example, a laminate film having a three-layer structure can be used in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 13B illustrates an example of a cross-sectional structure of the laminated secondary battery. FIG. 13A selectively illustrates one pair of electrodes and one electrolyte layer for the sake of clarity of the drawing; in the actual structure, a plurality of electrodes and a plurality of electrolyte layers are preferably included as illustrated in FIG. 13B.

In FIG. 13B, the number of electrodes is 16, for example. FIG. 13B illustrates a structure including eight layers of negative electrode current collectors 704 and eight layers of positive electrode current collectors 701, i.e., 16 layers in total. Note that FIG. 13B illustrates a cross section of a lead portion of the positive electrode, which is cut along the chain line in FIG. 13A, and the eight layers of negative electrode current collectors 704 are bonded to each other by ultrasonic welding. It is needless to say that the number of electrode layers is not limited to 16, and may be more than 16 or less than 16. The particle 190 described in Embodiment 1 is used in the positive electrode active material layer 702, whereby a secondary battery having high charge and discharge capacity and excellent cycle performance can be obtained. In the case where the number of electrode layers is large, the secondary battery can have higher capacity. In the case where the number of electrode layers is small, the secondary battery can be thin.

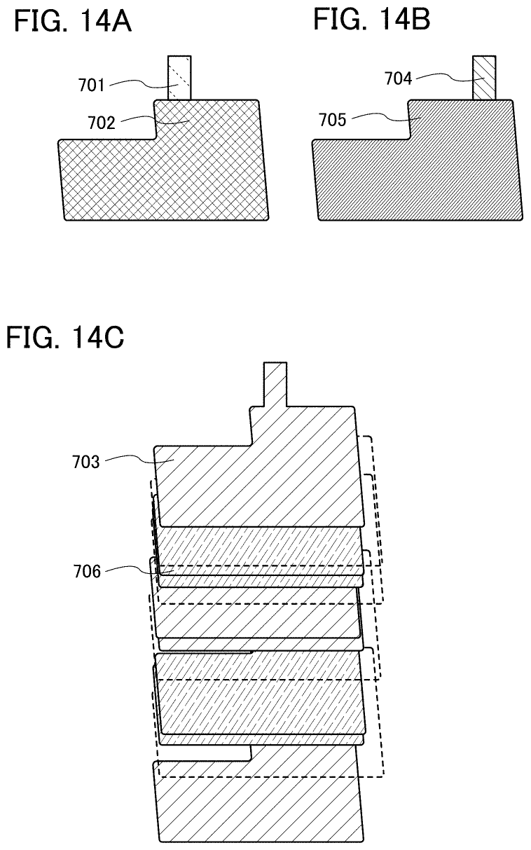

FIG. 14A illustrates a positive electrode including the L-shaped positive electrode current collector 701 and positive electrode active material layer 702 in the secondary battery 700. The positive electrode includes a region where the positive electrode current collector 701 is partly exposed (hereinafter, referred to as a tab region). FIG. 14B illustrates a negative electrode including the L-shaped negative electrode current collector 704 and negative electrode active material layer 705 in the secondary battery 700. The negative electrode includes a region where the negative electrode current collector 704 is partly exposed, that is, a tab region.

FIG. 14C illustrates a perspective view in which four layers of positive electrodes 703 and four layers of negative electrodes 706 are stacked. Note that in FIG. 14C, the electrolyte layers 707 provided between the positive electrodes 703 and the negative electrodes 706 are indicated by dotted lines for simplicity.

### <Wound Secondary Battery>

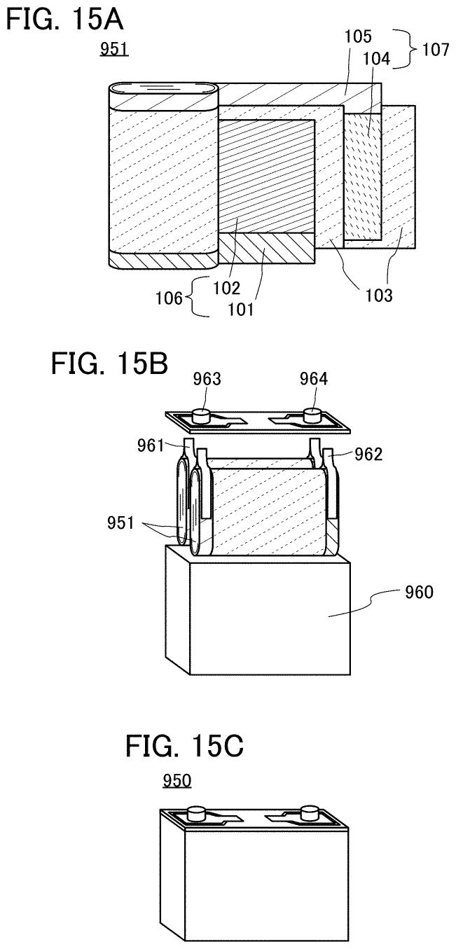

The secondary battery of one embodiment of the present invention may be a secondary battery 950 including a wound body 951 in an exterior body 960, as illustrated in FIG. 15A to FIG. 15C. The wound body 951 illustrated in FIG. 15A includes a negative electrode 107, a positive electrode 106, and an electrolyte layer 103. The negative electrode 107 includes a negative electrode active material layer 104 and a negative electrode current collector 105. The positive electrode 106 includes a positive electrode active material layer 102 and a positive electrode current collector 101. The electrolyte layer 103 has a larger width than the negative electrode active material layer 104 and the positive electrode active material layer 102, and is wound to overlap with the negative electrode active material layer 104 and the positive electrode active material layer 102. The electrolyte layer 103 containing a lithium-ion conductive polymer and a lithium salt can be wound as described above because of its flexibility. Note that in terms of safety, the width of the negative electrode active material layer 104 is preferably larger than that of the positive electrode active material layer 102. The wound body 951 having such a shape is preferable because of its high level of safety and high productivity.

As illustrated in FIG. 15B, the negative electrode 107 is electrically connected to a terminal 961. The terminal 961 is electrically connected to a terminal 963. The positive electrode 106 is electrically connected to a terminal 962. The terminal 962 is electrically connected to a terminal 964.

As illustrated in FIG. 15B, the secondary battery 950 may include a plurality of wound bodies 951. The use of the plurality of wound bodies 951 enables the secondary battery 950 to have higher charge and discharge capacity.

The particle 190 described in Embodiment 1 is used in the positive electrode 106, whereby the secondary battery 950 can have high charge and discharge capacity and excellent cycle performance.

This embodiment can be used in combination with the other embodiments.

### Embodiment 6

In this embodiment, an example in which the secondary battery illustrated in FIG. 15C is applied to an electric vehicle (EV) will be described.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 15A or the stacked-layer structure illustrated in FIG. 13A, FIG. 13B, FIG. 14A, FIG. 14B, or FIG. 14C. Alternatively, the first battery 1301a may be the all-solid-state battery in Embodiment 4. The use of the all-solid-state battery in Embodiment 4 as the first battery 1301a can achieve high capacity, improvement in safety, and reduction in size and weight.

Although this embodiment shows an example where the two first batteries 1301a (or first batteries 1301b) are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

In order to cut off electric power from the plurality of secondary batteries, the secondary batteries in the vehicle include a service plug or a circuit breaker which can cut off a high voltage without the use of equipment; these are provided in the first battery 1301a.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as an audio 1313, a power window 1314, and lamps 1315) through a DCDC circuit 1310.

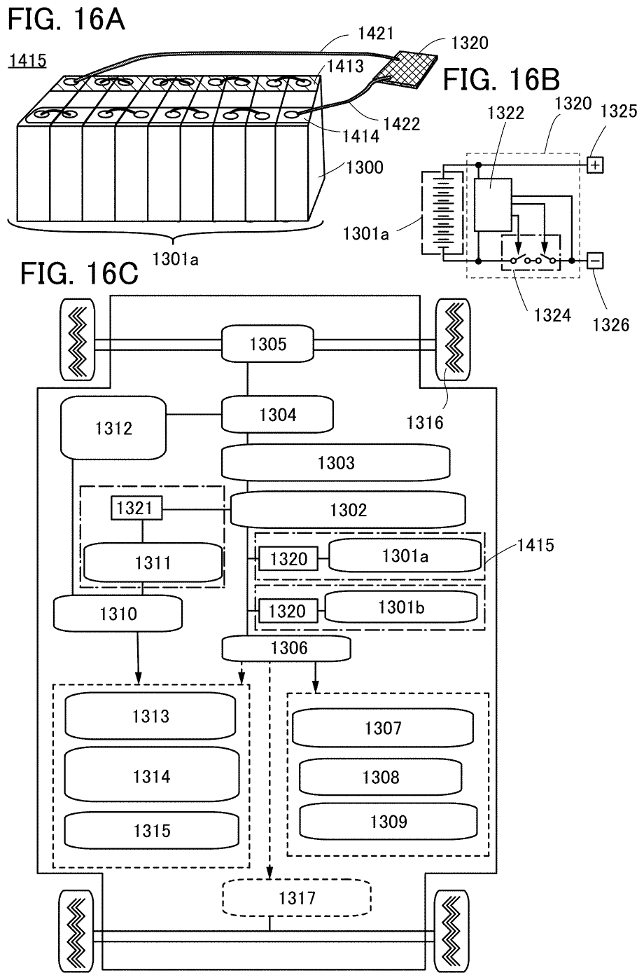

The first battery 1301a will be described with reference to FIG. 16A.

FIG. 16A illustrates an example in which nine rectangular secondary batteries 1300 form one battery pack 1415. The nine rectangular secondary batteries 1300 are connected in series; one electrodes are fixed by a fixing portion 1413 made of an insulator, and the other electrodes are fixed by a fixing portion 1414 made of an insulator. Although this embodiment shows an example in which the secondary batteries are fixed by the fixing portions 1413 and 1414, a structure in which the secondary batteries are stored in a battery container box (also referred to as a housing) may be employed. Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrodes are electrically connected to a control circuit portion 1320 through a wiring 1421. The other electrodes are electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the orientation of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. Alternatively, for example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Ion), high field-effect mobility (4 and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. The operating ambient temperatures of a transistor using an oxide semiconductor in its semiconductor layer are wider than those of a single crystal Si transistor and are higher than or equal to −40° C. and lower than or equal to 150° C., which causes less change of characteristics compared with a single crystal Si transistor when the secondary battery is heated. The off-state current of the transistor using an oxide semiconductor is lower than or equal to the lower measurement limit even at 150° C. independently of the temperature; meanwhile, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery whose positive electrode contains the particle 190 described in Embodiment 1, the synergy on safety can be obtained. The secondary battery whose positive electrode contains the particle 190 described in Embodiment 1 and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharge, prevention of overcurrent, control of overheating during charge, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers to not a state where the positive electrode and the negative electrode of a secondary battery are short-circuited so that charge and discharge are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: a plurality of charge and discharge cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharge, an output transistor of a charge circuit and an interruption switch can be turned off substantially at the same time.

FIG. 16B illustrates an example of a block diagram of the battery pack 1415 illustrated in FIG. 16A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors and/or p-channel transistors. The switch portion 1324 is not limited to including a switch using a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

FIG. 16C is a block diagram of a vehicle including a motor. The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium-ion secondary batteries in that they have a larger amount of self-discharge and are more likely to deteriorate due to a phenomenon called sulfation. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 4 may be used. The use of the all-solid-state battery in Embodiment 4 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through the control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charge.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU and/or a GPU.

External chargers installed at charge stations and the like have a 100 V outlet, a 200 V outlet, and a three-phase 200 V outlet with 50 kW, for example. Furthermore, charge can be performed by electric power supplied from an external charge equipment with a contactless power feeding method or the like.

For fast charge, secondary batteries that can withstand charge with a high voltage have been desired to perform charge in a short time.

The above secondary battery in this embodiment uses the particle 190 described in Embodiment 1 and thus includes a high-density positive electrode. Furthermore, graphene is used as a conductive material and an electrode layer is formed thick so that a reduction in capacity can be inhibited while the loading amount is increased. Moreover, the maintenance of high capacity can be obtained as synergy; thus, it is possible to achieve a secondary battery whose electrical characteristics are significantly improved. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the use of the particle 190 described in Embodiment 1 can increase the operating voltage of the secondary battery, and the increase in charge voltage can increase the available capacity. Moreover, using the particle 190 described in Embodiment 1 in the positive electrode can provide an automotive secondary battery having excellent cycle performance.

This embodiment can be freely combined with the other embodiments.

### Embodiment 7

In this embodiment, examples of providing vehicles, buildings, moving vehicles, electronic devices, and the like with the secondary battery of one embodiment of the present invention will be described.

Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. Furthermore, the moving vehicle is not limited to an automobile. Examples of moving vehicles include a train, a monorail train, a ship, and a flying object (a helicopter, an unmanned aircraft (a drone), an airplane, and a rocket), an electric bicycle, and an electric motorcycle, and the secondary battery of one embodiment of the present invention can be used for the moving vehicles.

The secondary battery of this embodiment may be used in ground-based charge apparatuses provided for houses and charge stations provided in commerce facilities.

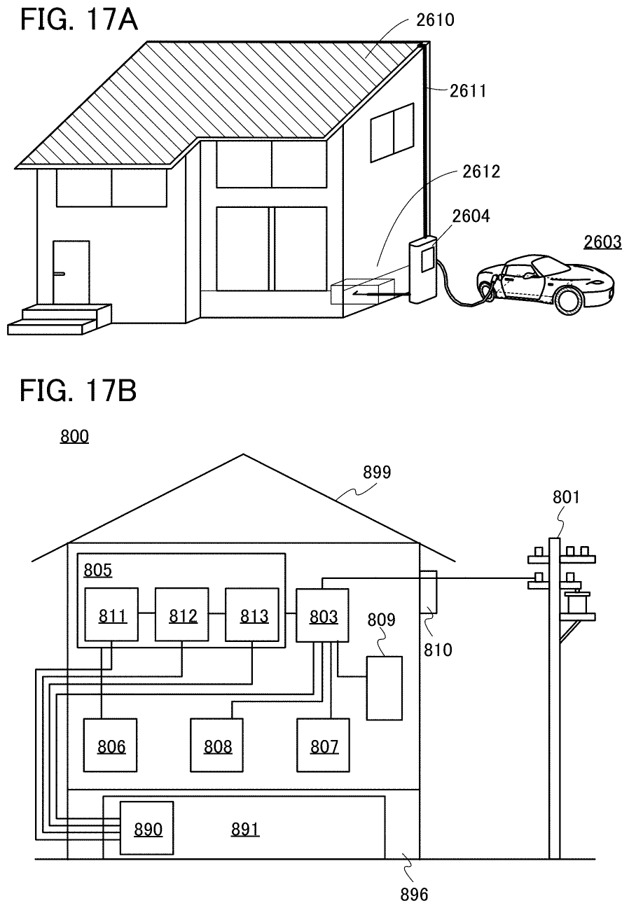

Examples in which a building is provided with the secondary battery of one embodiment of the present invention will be described with reference to FIG. 17A and FIG. 17B.

The house illustrated in FIG. 17A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charge device 2604. The power storage device 2612 can be charged with electric power generated by the solar panel 2610. A secondary battery included in a vehicle 2603 can be charged with the electric power stored in the power storage device 2612 through the charge device 2604. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 17B illustrates an example of a power storage device 800 of one embodiment of the present invention. As illustrated in FIG. 17B, a power storage device 891 of one embodiment of the present invention is provided in an underfloor space 896 of a building 899. Furthermore, the control circuit described in Embodiment 6 may be provided in the power storage device 891, and synergy on safety can be obtained with the use of the secondary battery including the particle 190 described in Embodiment 1 for the positive electrode for the power storage device 891. The secondary battery including the control circuit described in Embodiment 6 and the particle 190 described in Embodiment 1 in the positive electrode can greatly contribute to elimination of accidents due to the power storage device 891 including a secondary battery, such as fires.

The power storage device 891 is provided with a control device 890, and the control device 890 is electrically connected to a distribution board 803, a power storage controller 805 (also referred to as control device), an indicator 806, and a router 809 through wirings.

Electric power is transmitted from a commercial power source 801 to the distribution board 803 through a service wire mounting portion 810. Moreover, electric power is transmitted to the distribution board 803 from the power storage device 891 and the commercial power source 801, and the distribution board 803 supplies the transmitted electric power to a general load 807 and a power storage load 808 through outlets (not illustrated).

The general load 807 is, for example, an electrical device such as a TV or a personal computer. The power storage load 808 is, for example, an electrical device such as a microwave, a refrigerator, or an air conditioner.

The power storage controller 805 includes a measuring portion 811, a predicting portion 812, and a planning portion 813. The measuring portion 811 has a function of measuring the amount of electric power consumed by the general load 807 and the power storage load 808 during a day (e.g., from midnight to midnight). The measuring portion 811 may also have a function of measuring the amount of electric power of the power storage device 891 and the amount of electric power supplied from the commercial power source 801. The predicting portion 812 has a function of predicting, on the basis of the amount of electric power consumed by the general load 807 and the power storage load 808 during a given day, the demand for electric power consumed by the general load 807 and the power storage load 808 during the next day. The planning portion 813 has a function of making a charge and discharge plan of the power storage device 891 on the basis of the demand for electric power predicted by the predicting portion 812.

An indicator 806 can show the amount of electric power consumed by the general load 807 and the power storage load 808 that is measured by the measuring portion 811. An electrical device such as a TV or a personal computer can also show it through the router 809. Furthermore, a portable electronic terminal such as a smartphone or a tablet can also show it through the router 809. The indicator 806, the electrical device, and the portable electronic terminal can also show, for example, the demand for electric power depending on a time period (or per hour) that is predicted by the predicting portion 812.

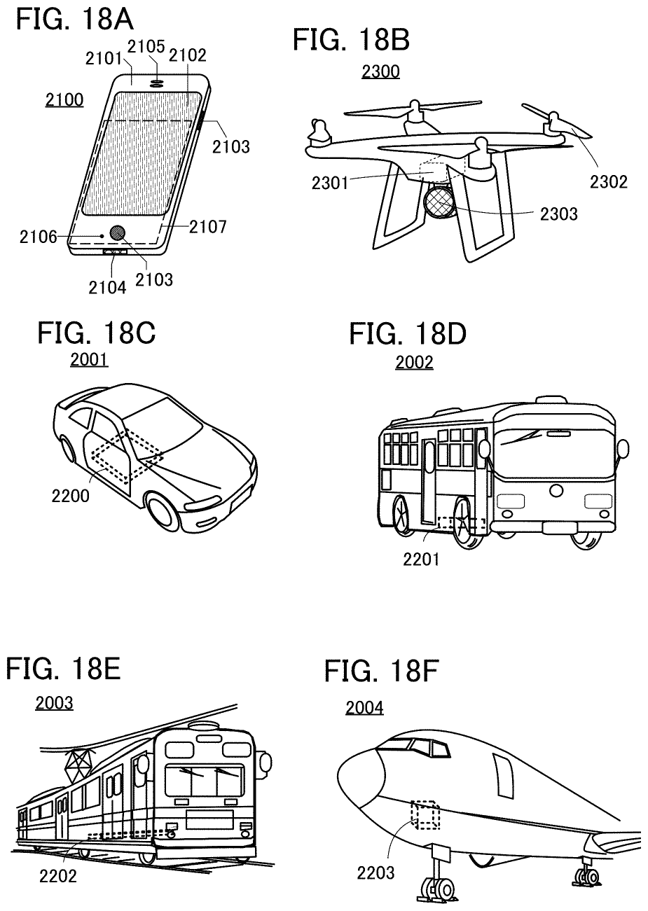

Next, examples of providing electronic devices with the secondary battery of one embodiment of the present invention are illustrated in FIG. 18A and FIG. 18B. FIG. 18A illustrates an example of a mobile phone. A mobile phone 2100 includes a display portion 2102 installed in a housing 2101, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a body-temperature sensor, a touch sensor, a pressure sensitive sensor, or an acceleration sensor is preferably mounted.

FIG. 18B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery including the particle 190 described in Embodiment 1 in the positive electrode has high energy density and high level of safety, and thus can be used safely for a long time over a long period of time and is preferable as the secondary battery included in the unmanned aircraft 2300.

Next, examples of a transport vehicle using one embodiment of the present invention are illustrated in FIG. 18C to FIG. 18F. An automobile 2001 illustrated in FIG. 18C is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, an example of the secondary battery described in Embodiment 5 is provided at one position or several positions. In addition, using the secondary battery including the particle 190 described in Embodiment 1 in the positive electrode can create synergy on safety. The secondary battery including the particle 190 described in Embodiment 1 in the positive electrode can greatly contribute to elimination of accidents due to secondary batteries, such as fires. The automobile 2001 illustrated in FIG. 18C includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charge equipment through a plug-in system and/or a contactless charge system, for example. In charging, a given method such as CHAdeMO (registered trademark) and Combined Charging System may be employed as a charge method, the standard of a connector, and the like as appropriate. The secondary battery may be a charge station provided in a commerce facility or a household power source. For example, a plug-in technique enables an exterior power supply to charge the power storage device incorporated in the automobile 2001. The charge can be performed by converting AC electric power into DC electric power through a converter such as an ACDC converter.

Although not illustrated, the vehicle can include a power receiving device so as to be charged by being supplied with power from an above-ground power transmitting device in a contactless manner. For the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and/or moves. To supply power in such a contactless manner, an electromagnetic induction method and/or a magnetic resonance method can be used.

FIG. 18D illustrates a large transporter 2002 including a motor controlled by electricity, as an example of a transport vehicle. The secondary battery module of the transporter 2002 has a cell unit of four secondary batteries with 3.5 V or more and 4.7 V or lower, and 48 cells are connected in series to have 170 V as the maximum voltage. A battery pack 2201 has the same function as that in FIG. 18A except that the number of secondary batteries forming the secondary battery module of the battery pack 2201 or the like is different; thus, the description is omitted.

FIG. 18E illustrates a large transportation vehicle 2003 including a motor controlled by electricity as an example. The secondary battery module of the transportation vehicle 2003 has more than 100 secondary batteries with 3.5 V or more and 4.7 V or lower connected in series, and the maximum voltage is 600 V, for example. Thus, the secondary batteries are required to have few variations in the characteristics. When the secondary battery including the particle 190 described in Embodiment 1 in the positive electrode is used, a highly safe secondary battery can be manufactured, and in light of the yield, mass production can be performed at low cost. A battery pack 2202 has the same function as that in FIG. 18C except that the number of secondary batteries forming the secondary battery module of the battery pack 2202 or the like is different; thus, the detailed description is omitted.

FIG. 18F illustrates an aircraft 2004 including a combustion engine as an example. The aircraft 2004 illustrated in FIG. 18F can be regarded as a portion of a transportation vehicle since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 18C except that the number of secondary batteries forming the secondary battery module of the battery pack 2203 or the like is different; thus, the detailed description is omitted.

In this embodiment, examples in which a motorcycle or a bicycle is provided with the power storage device of one embodiment of the present invention will be described.

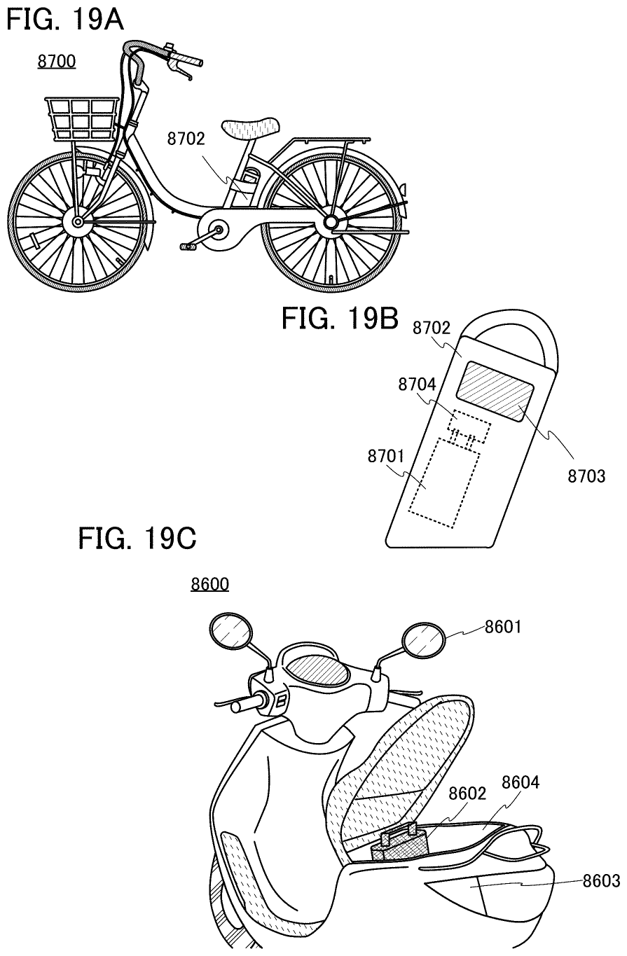

Next, an example of an electric bicycle in which the secondary battery of one embodiment of the present invention is used is illustrated in FIG. 19A. The power storage device of one embodiment of the present invention can be used for an electric bicycle 8700 illustrated in FIG. 19A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 19B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may be provided with the small solid-state secondary battery illustrated in FIG. 11A and FIG. 11B. When the small solid-state secondary battery illustrated in FIG. 11A and FIG. 11B is provided in the control circuit 8704, electric power can be supplied to store data in a memory circuit included in the control circuit 8704 for a long time. When the control circuit 8704 is used in combination with the secondary battery including the particle 190 described in Embodiment 1 in the positive electrode, the synergy on safety can be obtained. The secondary battery including the particle 190 described in Embodiment 1 in the positive electrode and the control circuit 8704 can greatly contribute to elimination of accidents due to secondary batteries, such as fires.

Next, FIG. 19C illustrates an example of a motorcycle in which the secondary battery of one embodiment of the present invention is used. A motor scooter 8600 illustrated in FIG. 19C includes a power storage device 8602, side mirrors 8601, and indicator lights 8603. The power storage device 8602 can supply electricity to the indicator lights 8603.

In the motor scooter 8600 illustrated in FIG. 19C, the power storage device 8602 can be stored in a storage unit under seat 8604. The power storage device 8602 can be stored in the storage unit under seat 8604 even with a small size.

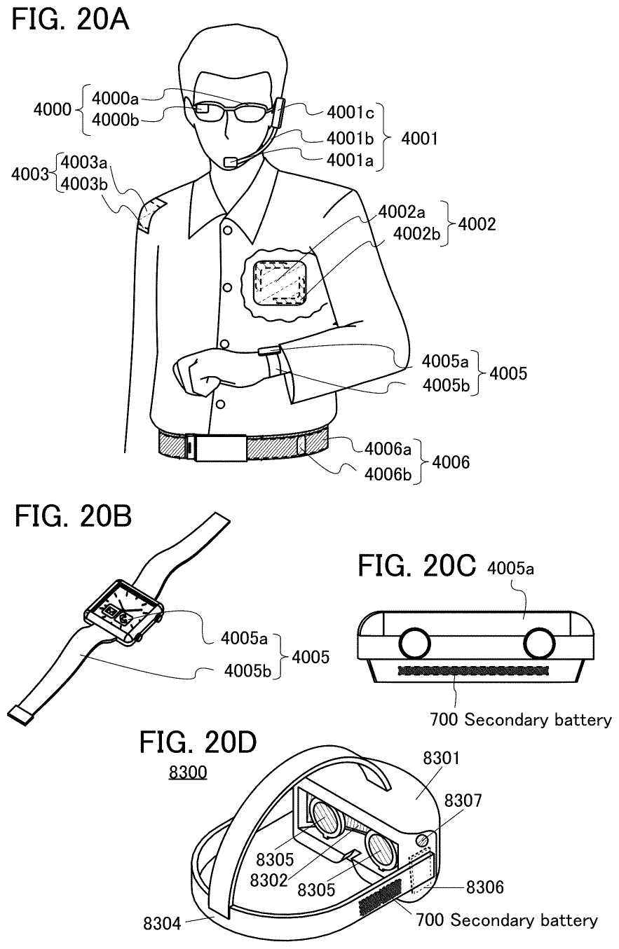

FIG. 20A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 20A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. The provision of the secondary battery including the particle 190 described in Embodiment 1 in the positive electrode achieves high capacity and a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. The provision of the secondary battery including the particle 190 described in Embodiment 1 in the positive electrode achieves high capacity and a structure that accommodates space saving due to a reduction in size of the housing.

The secondary battery including the particle 190 described in Embodiment 1 in the positive electrode can be provided in a device 4002 that can be directly attached to a human body. A secondary battery 4002b can be provided in a thin housing 4002a of the device 4002. The provision of the secondary battery including the particle 190 described in Embodiment 1 in the positive electrode achieves high capacity and a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. The provision of the secondary battery including the particle 190 described in Embodiment 1 in the positive electrode achieves high capacity and a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. The provision of the secondary battery including the particle 190 described in Embodiment 1 in the positive electrode achieves high capacity and a structure that accommodates space saving due to a reduction in size of the housing.

The secondary battery including the particle 190 described in Embodiment 1 in the positive electrode can be provided in a watch-type device 4005. The watch-type device 4005 includes a display portion 4005a and a belt portion 4005b, and the secondary battery can be provided in the display portion 4005a or the belt portion 4005b. The provision of the secondary battery including the particle 190 described in Embodiment 1 in the positive electrode achieves high capacity and a structure that accommodates space saving due to a reduction in size of the housing.

The display portion 4005a can display various kinds of information such as time and reception information of an e-mail and an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 20B is a perspective view of the watch-type device 4005 that is detached from an arm.

FIG. 20C is a side view. FIG. 20C illustrates a state where the secondary battery 700 is incorporated in the watch-type device 4005. Although the external shape is different from that of the secondary battery 700 in FIG. 13, the inner structure is the same; thus, the same reference numeral is used. The secondary battery 700, which is small and lightweight, is provided to overlap with the display portion 4005a.

A head-mounted display 8300 illustrated in FIG. 20D includes a housing 8301, a display portion 8302, a band-shaped fixing unit 8304, a pair of lenses 8305, and the secondary battery 700. Note that although the external shape is different from that of the secondary battery 700 in FIG. 13, the inner structure is the same; thus, the same reference numeral is used. In addition, an example is shown where two secondary batteries 700 each having a rectangular shape are provided because they are fixed to the fixing unit 8304.

As illustrated in FIG. 20D, the head-mounted display 8300 preferably includes a circuit unit 8306 and an imaging device 8307.

A display portion 8302 included in the head-mounted display 8300 is supplied with image data (hereinafter referred to as image data A1). The image data A1 contains image data generated by the circuit unit 8306 included in the head-mounted display 8300 (hereinafter, image data B1) and data generated by a data processing unit (hereinafter, data C1). Alternatively, the image data B1 may be generated by an external circuit outside the head-mounted display 8300. The data C1 is data on a controller, which is updated as needed when the user operates the controller.

The image data B1 is combined with the data C1 updated as needed to generate the image data A1 and the image data A1 is displayed on the display portion 8302 of the head-mounted display 8300, whereby the head-mounted display 8300 can be used as a VR (Virtual Reality) device, an AR (Augmented Reality) device, an MR (Mixed Reality) device, or the like.

The head-mounted display 8300 may include an eye-gaze input device. In generating the image data A1, the data processing unit may use a signal detected by the eye-gaze input device in addition to the image data B1 and the data C1.

The eye-gaze input device can perform eye tracking. Eye tracking can be performed by sensing the iris or the pupil of a human. Eye tracking can also be performed by sensing the movement of eyeballs and eyelids. Furthermore, eye tracking can also be performed in such a manner that an electrode is provided so as to be in contact with a user and a current flowing through the electrode with the movement of the eyeballs is sensed.

The image data A1 and sound data can be combined with each other to generate video data. The display portion 8302 has a function of displaying the video data.

The head-mounted display 8300 preferably includes a sensor element having a function of receiving electromagnetic waves emitted from a light-emitting device. Here, as a structure including a sensor element having a function of receiving electromagnetic waves emitted from the light-emitting device, the imaging device 8307 can be used.

Since the head-mounted display 8300 is desired to be small and lightweight, with the use of the particle 190 described in Embodiment 1 in the positive electrode of the secondary battery 700, the secondary battery 700 can have high energy density and a small size.

This embodiment can be used in appropriate combination with the other embodiments.

### Example 1

In this example, the calculation results of the proportions of the volumes, the areas, and the radii of the region 191 and the region 193 in the particle 190 and charge and discharge capacity will be described.

For the calculation simplicity, the particle 190 of one embodiment of the present invention is assumed to be spherical like the particle 190 illustrated in FIG. 2A. The region 192 is excluded in the calculation in this example because the region 192 does not directly relate to the charge and discharge capacity.

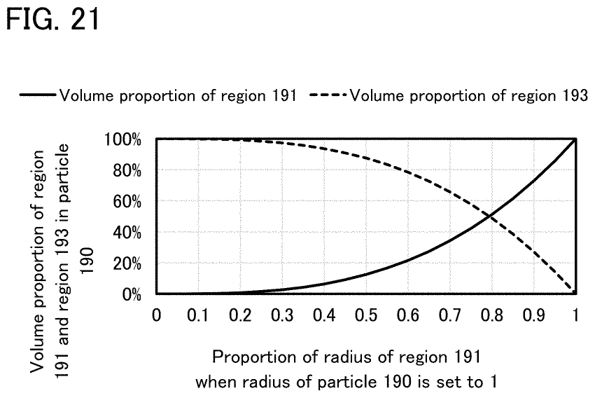

FIG. 21 is a graph showing the proportion of the radius of the region 191 when the radius of the particle 190 is set to 1 and the volume proportions of the region 191 and the region 193.

As shown in FIG. 21, the volume proportions of the region 191 and the region 193 are substantially equal when the radius of the region 191 is 0.8.

Although not shown, the cross-sectional area proportion can be obtained by raising the radius proportion to the second power. For example, when the radius proportion of the region 191 is 0.02, the area of the region 191 is 0.04% of 5190. When the radius proportion of the region 191 is 0.55, the area of the region 191 is approximately 30% of S₁₉₀. When the radius proportion of the region 191 is 0.8, the area of the region 191 is approximately 64% of S₁₉₀. When the radius proportion of the region 191 is 0.95, the area of the region 191 is approximately 90% of 5190. When the radius proportion of the region 191 is 0.98, the area of the region 191 is approximately 96% of S₁₉₀.

As described in the embodiment, the cross-sectional area proportion of the region 191, the region 193, or the like can be estimated by cross-sectional observation and various kinds of line analyses, plane analyses, or the like after the cross section is exposed by processing the particle 190. It is preferable that a cross section sufficiently reflecting the internal structure of the particle 190 be used to estimate the proportion of the area. For example, a cross section whose maximum width is 80% or more of the average particle diameter (D50) is preferably used.

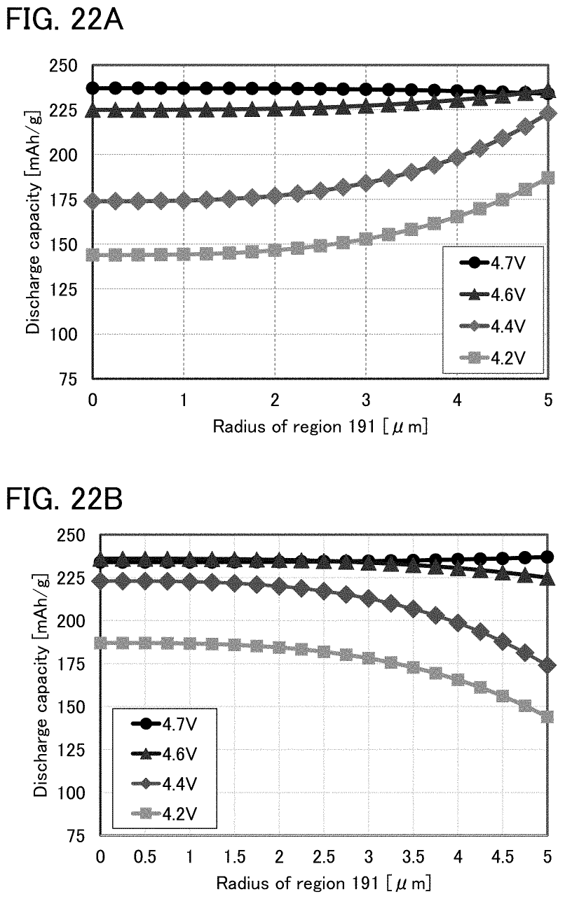

FIG. 22A is a graph showing the radius of the region 191 and discharge capacity per weight in the case where the radius of the particle 190 is 5 μm, and NCM811 (LiNiₓCo_{y}Mn_{z}O₂, x:y:z=8:1:1) and LiCoO₂ are used for the region 191 that is the core and the region 193 that is the shell, respectively. The calculation was performed for each of the cases where the charge voltages were 4.2 V, 4.4 V, 4.6 V, and 4.7 V.

As shown in FIG. 22A, in 4.2 V to 4.6 V, the tendency was found that the larger the radius of the region 191 that is the core was, the discharge capacity increased. In this case, it was shown that the radius of the region 191 was preferably greater than or equal to 4 μm (greater than or equal to 0.8 of the radius of the particle 190), further preferably greater than or equal to 4.75 μm (greater than or equal to 0.95 of the radius of the particle 190).

FIG. 22B is a graph showing the radius of the region 191 and discharge capacity per weight in the case where the radius of the particle 190 is 5 μm, and LiCoO₂ and NCM811 (LiNiₓCo_{y}Mn_{z}O₂, x:y:z=8:1:1) are used for the region 191 that is the core and the region 193 that is the shell, respectively. The calculation was performed for each of the cases where the charge voltages were 4.2 V, 4.4 V, 4.6 V, and 4.7 V.

As shown in FIG. 22B, in 4.2 V to 4.6 V, the tendency was found that the smaller the radius of the region 191 that is the core was, the discharge capacity increased. In this case, it was shown that the radius of the region 191 was preferably less than or equal to 3.5 μm (less than or equal to 0.7 of the radius of the particle 190), further preferably less than or equal to 3.0 μm (less than or equal to 0.6 of the radius of the particle 190).

### REFERENCE NUMERALS

100: positive electrode active material, 101: positive electrode current collector, 102: positive electrode active material layer, 103: electrolyte layer, 104: negative electrode active material layer, 105: negative electrode current collector, 106: positive electrode, 107: negative electrode, 190: particle, 191: region, 192: region, 193: region, 193a: region, 193b: region, 194: region, 195: region, 196a: region, 196b: region, 196c: region, 196d: region

1. A secondary battery comprising a positive electrode active material,
wherein the positive electrode active material comprises:
a first region; and
a second region positioned inward from the first region,
wherein each of the first region and the second region comprises:
lithium;
oxygen; and
one or more selected from a first transition metal, a second transition metal, and a third transition metal, and
wherein the first region and the second region differ in a concentration of at least one of the first transition metal, the second transition metal, and the third transition metal.

2. The secondary battery according to claim 1,
wherein the positive electrode active material comprises an impurity layer comprising an impurity element, and
wherein the impurity layer is between the first region and the second region.

3. The secondary battery according to claim 2,
wherein the impurity layer is configured to inhibit interdiffusion of elements in the first region and the second region.

4. The secondary battery according to claim 2,
wherein the impurity element is at least one of titanium, fluorine, magnesium, aluminum, zirconium, calcium, gallium, niobium, phosphorus, boron, and silicon.

5. A secondary battery comprising a positive electrode active material,
wherein the positive electrode active material comprises:
a first region;
a second region positioned inward from the first region;
a first impurity layer positioned on an outer side than the first region; and
a second impurity layer between the first region and the second region,
wherein each of the first region and the second region comprises:
lithium;
oxygen; and
one or more selected from a first transition metal, a second transition metal, and a third transition metal,
wherein the first region and the second region differ in a concentration of at least one of the first transition metal, the second transition metal, and the third transition metal, and
wherein each of an impurity element comprised in the first impurity layer and an impurity element comprised in the second impurity layer is at least one of titanium, fluorine, magnesium, aluminum, zirconium, calcium, gallium, niobium, phosphorus, boron, and silicon.

6. The secondary battery according to claim 5,
wherein the second impurity layer is configured to inhibit interdiffusion of elements in the first region and the second region.

7. The secondary battery according to claim 1,
wherein the first transition metal is nickel, the second transition metal is cobalt, and the third transition metal is manganese,
wherein a concentration of the cobalt is higher in the first region than in the second region, and
wherein concentrations of the nickel and the manganese are lower in the first region than in the second region.

8. The secondary battery according to claim 1,
wherein the first region promotes diffusion of the lithium due to charge and discharge to contribute to stabilization of the positive electrode active material.

9. The secondary battery according to claim 1,
wherein the secondary battery comprises a carbon material, and
wherein the carbon material is at least one of fibrous carbon, graphene, and particulate carbon.

10. An electronic device comprising the secondary battery according to claim 1.

11. A vehicle comprising the secondary battery according to claim 1.

12. The secondary battery according to claim 5,
wherein the first transition metal is nickel, the second transition metal is cobalt, and the third transition metal is manganese,
wherein a concentration of the cobalt is higher in the first region than in the second region, and
wherein concentrations of the nickel and the manganese are lower in the first region than in the second region.

13. The secondary battery according to claim 5,
wherein the first region promotes diffusion of the lithium due to charge and discharge to contribute to stabilization of the positive electrode active material.

14. The secondary battery according to claim 5,
wherein the secondary battery comprises a carbon material, and
wherein the carbon material is at least one of fibrous carbon, graphene, and particulate carbon.

15. An electronic device comprising the secondary battery according to claim 5.

16. A vehicle comprising the secondary battery according to claim 5.
